(19) United States
(12) Patent Application Publication
(10) Pub. No.: US 2013/0150165 A1
(43) Pub. Date: Jun. 13, 2013

(54) INFORMATION PROCESSING SYSTEM, INFORMATION PROCESSOR, INFORMATION PROCESSING METHOD AND RECORDING MEDIUM

(71) Applicant: Nintendo Co., Ltd., Kyoto (JP)

(72) Inventors: Yuki TAKAHASHI, Kyoto (JP); Kiyofumi FUNAHASHI, Kyoto (JP); Yasumasa MIYOSHI, Kyoto (JP); Hiroki TAKUMA, Kyoto (JP)

(73) Assignee: NINTENDO CO., LTD., Kyoto (JP)

(21) Appl. No.: 13/693,381

(22) Filed: Dec. 4, 2012

(30) Foreign Application Priority Data
Dec. 8, 2011 (JP) 2011-269383

(51) Int. Cl. A63F 13/06; G06F 3/041

(52) U.S. Cl. CPC A63F 13/06; G06F 3/041
USPC 463/37

(57) ABSTRACT

An example system includes a display part that displays an image; a first touch panel that is provided in the display part and detects a touch position; a second touch panel that detects a touch position; a change calculating part that calculates a change in the touch position on the second touch panel; and an information processing part that executes information processing in accordance with the touch position detected by the first touch panel and the change calculated by the change calculating part.

### CROSS-REFERENCE TO RELATED APPLICATIONS

This application is based upon and claims the benefit of priority of the prior Japanese Patent Application No. 2011-269383, filed on Dec. 18, 2011, the entire contents of which are incorporated herein by reference.

### FIELD

The present invention relates to an information processing system, an information processor, an information processing method and a recording medium to be employed for accepting an operation performed by a user with a pointing device such as a touch panel and performing information processing in accordance with the accepted operation.

### BACKGROUND AND SUMMARY

Electronic devices including touch panels as user interfaces are now widespread. Touch panels are employed in electronic devices such as portable game devices, cellular phones (smartphones) and tablet terminals. Since a touch panel may be provided on a surface of a display part such as a liquid crystal display, an electronic device may be downsized by using a touch panel.

Furthermore, in an electronic device including a touch panel, a user may perform an operation merely by touching, with a finger, an object such as a character, an icon or a menu item displayed in a display part, and hence, the user may perform an intuitive operation. Therefore, an electronic device including a touch panel is advantageously user-friendly.

According to an aspect of the embodiment, an information processing system includes: a display part that displays an image; a first touch panel that is provided in the display part and detects a touch position; a second touch panel that detects a touch position; a change calculating part that calculates a change in the touch position on the second touch panel; and an information processing part that executes information processing in accordance with the touch position detected by the first touch panel and the change calculated by the change calculating part.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 shows an example non-limiting schematic diagram for the appearance of an information processor according to an embodiment.

FIG. 2 shows an example non-limiting block diagram for a structure of the information processor according to the embodiment.

FIG. 3 shows an example non-limiting schematic diagram for explaining a cursor moving operation.

FIG. 4 shows an example non-limiting schematic diagram for explaining the cursor moving operation.

FIG. 5 shows an example non-limiting flowchart illustrating procedures in cursor moving processing executed by a processing unit.

FIG. 6 shows an example non-limiting schematic diagram for explaining an icon moving operation.

FIG. 7 shows an example non-limiting schematic diagram for explaining an icon moving operation.

FIG. 8 shows an example non-limiting schematic diagram for explaining an icon moving operation.

FIG. 9 shows an example non-limiting flowchart illustrating procedures in icon moving processing executed by the processing unit.

FIG. 10 shows an example non-limiting schematic diagram for explaining another icon moving operation.

FIG. 11 shows an example non-limiting schematic diagram for explaining a parameter setting operation.

FIG. 12 shows an example non-limiting schematic diagram for explaining the parameter setting operation.

FIG. 13 shows an example non-limiting flowchart illustrating procedures in parameter setting processing executed by the processing unit.

FIG. 14 shows an example non-limiting schematic diagram for explaining a graphics operation.

FIG. 15 shows an example non-limiting schematic diagram for explaining the graphics operation.

FIG. 16 shows an example non-limiting schematic diagram for explaining the graphics operation.

FIG. 17 shows an example non-limiting schematic diagram for explaining the graphics operation.

FIG. 18 shows an example non-limiting flowchart illustrating procedures in graphics operation processing executed by the processing unit.

FIG. 19 shows an example non-limiting schematic diagram for explaining a game control operation.

FIG. 20 shows an example non-limiting schematic diagram for explaining the game control operation.

FIG. 21 shows an example non-limiting schematic diagram for explaining the game control operation.

FIG. 22 shows an example non-limiting flowchart illustrating procedures in game control operation accepting processing executed by the processing unit.

FIG. 23 shows an example non-limiting flowchart illustrating procedures in the game control operation accepting processing executed by the processing unit.

FIGS. 24A and 24B show an example non-limiting schematic diagram for the appearance of a game device according to Modification 1.

FIG. 25 shows an example non-limiting schematic diagram for the appearance of a game device according to Modification 2.

FIG. 26 shows an example non-limiting schematic diagram for the appearance of a game system according to Modification 3.

### DETAILED DESCRIPTION OF NON-LIMITING EXAMPLE EMBODIMENT

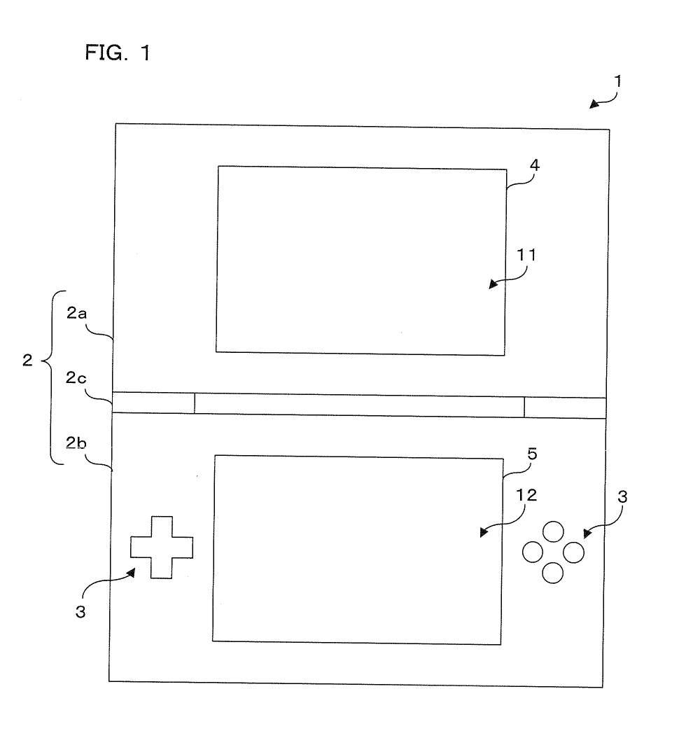

An information processing system will now be specifically described by taking a portable game device as an example with reference to drawings illustrating an embodiment thereof. FIG. 1 is a schematic diagram illustrating the appearance of an information processor according to this embodiment. A game device 1 of this embodiment includes a housing 2 in which a first housing 2a and a second housing 2b are connected to each other through a hinge portion 2c. Each of the first housing 2a and the second housing 2b is in a flat substantially rectangular parallelepiped shape, and these housings are rotatably connected to each other on long sides thereof through the hinge portion 2c. Therefore, the housing 2 of the game device 1 may be opened/closed so that the first housing 2a and the second housing 2b may abut each other on one faces thereof.

In the first housing 2a of the game device 1, a first display part 4 in a substantially rectangular shape is provided in substantially the center of a face opposing a user of the game device 1 when the housing 2 is opened. Similarly, in the second housing 2b, a second display part 5 in a substantially rectangular shape is provided in substantially the center of a face opposing a user of the game device 1 when the housing 2 is opened. In the second housing 2b, an operation part 3 is further provided on right and left sides of the second display part 5. The operation part 3 includes hardware keys such as a cross-key and push buttons.

The game device 1 further includes a first touch panel 11 provided so as to cover the first display part 4 and a second touch panel 12 provided so as to cover the second display part 5. Therefore, the game device 1 may execute information processing related to a game in accordance with a touching operation performed by a user on the first touch panel 11 covering the first display part 4 and a touching operation performed by the user on the second touch panel 12 covering the second display part 5.

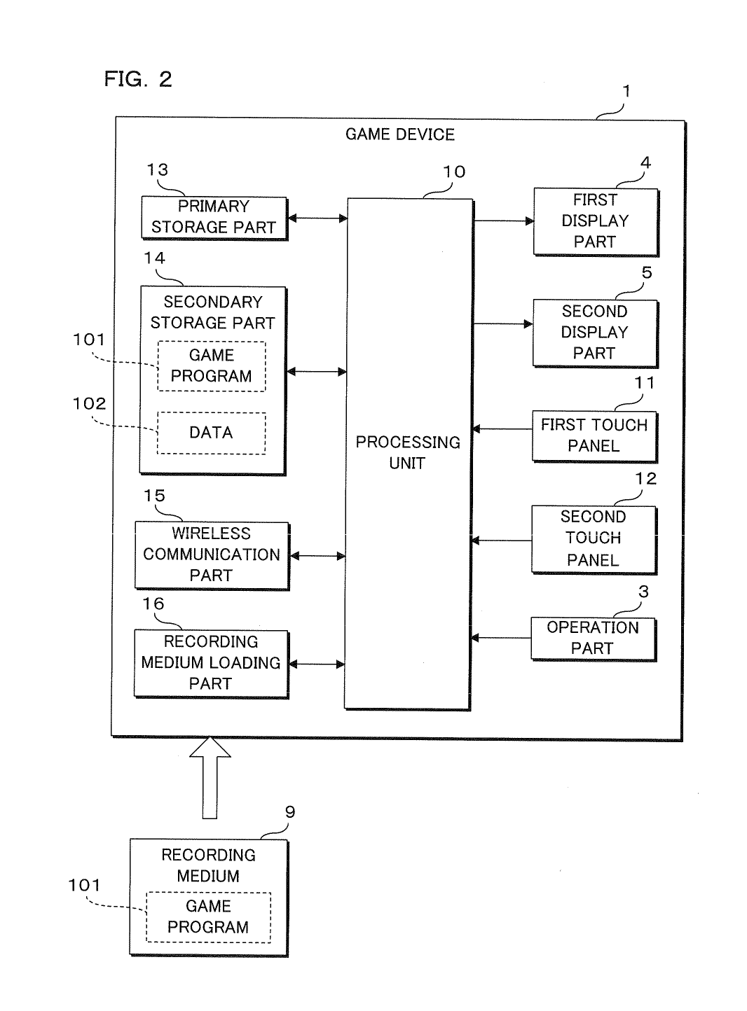

FIG. 2 is a block diagram illustrating the configuration of the information processor according to the embodiment. The game device 1 of the present embodiment includes a processing unit 10 using an arithmetic processing unit such as a CPU (Central Processing Unit) or an MPU (MicroProcessing Unit). The processing unit 10 performs various arithmetic processing related to a game by reading a game program 101 stored in a secondary storage part 14 onto a primary storage part 13 and executing the read program. Examples of the arithmetic processing are processing for determining a user operation performed on the operation part 3, the first touch panel 11 or the second touch panel 12, and processing for updating an image to be displayed in the first display part 4 or the second display part 5 in accordance with a content of an operation.

The primary storage part 13 includes a memory device such as an SRAM (Static Random Access Memory) or a DRAM (Dynamic Random Access Memory). A game program 101, data 102 and the like necessary for performing processing by the processing unit 10 are read from the secondary storage part 14 to be stored in the primary storage part 13. Furthermore, the primary storage part 13 temporarily stores various data created during arithmetic processing performed by the processing unit 10.

The secondary storage part 14 includes a nonvolatile memory device having a larger capacity than the primary storage part 13, such as a flash memory or a hard disk. The secondary storage part 14 stores a game program 101 and data 102 downloaded by a wireless communication part 15 from an external server device (not shown) or the like. The secondary storage part 14 also stores a game program 101, data 102 and the like read from a recording medium 9 loaded in a recording medium loading part 16.

The wireless communication part 15 transmits/receives data to/from an external device through a wireless LAN (Local Area Network), a cellular phone network or the like. Since the game device 1 has the wireless communication function, a user may download a game program 101, data 102 and the like from an external server device and store them in the secondary storage part 14. Furthermore, a user may use the communication function of the wireless communication part 15 for playing the same game in cooperation with or against another user at a remote place.

The recording medium loading part 16 has a structure in which a card-type, cassette-type or another type recording medium 9 may be detachably loaded. The recording medium loading part 16 reads a game program 101 and the like recorded in the loaded recording medium 9 and stores the read program and the like in the secondary storage part 14. Note that it is not necessary for the game device 1 to store, in the second storage part 14, the game program 101 recorded in the recording medium 9. The processing unit 10 may read the game program 101 directly from the recording medium 9 loaded in the recording medium loading part 16 onto the primary storage part 13 for executing the read program.

As mentioned above, the game device 1 includes the operation part 3, the first touch panel 11 and the second touch panel 12 for accepting a user operation. The operation part 3 includes one or a plurality of hardware keys. The operation part 3 inputs, to the processing unit 10, a signal in accordance with a hardware key operated by a user. The hardware keys included in the operation part 3 are not limited to those used by a user for performing game control operations. The operation part 3 may include, for example, a hardware key for turning on/off the game device 1 and a hardware key for adjusting a sound volume.

The first touch panel 11 and the second touch panel 12 are, for example, capacitive type touch panels or resistive film type touch panels and are provided so as to cover the first display part 4 and the second display part 5, respectively. Each of the first touch panel 11 and the second touch panel 12 detects a touch position touched with a finger of a user, a pen type input tool (what is called a touch pen) or the like and informs the processing unit 10 of the detected touch position. Furthermore, each of the first touch panel 11 and the second touch panel 12 may employ a structure in which simultaneous touches in a plurality of positions (what is called multiple touches) may be detected, and in this case, the processing unit 12 is informed of the plural touch positions.

Furthermore, the game device 1 includes the two image display parts of the first display part 4 and the second display part 5 for displaying images related to a game. Each of the first display part 4 and the second display part 5 includes a display device such as a liquid crystal panel or a PD (Plasma Display Panel) and displays an image corresponding to image data supplied from the processing unit 10. The first display part 4 is provided in the first housing 2a and the second display part 5 is provided in the second housing 2b. In the housing 2 of the game device 1, the first housing 2a may be rotated in relation to the second housing 2b or the second housing 2b may be rotated in relation to the first housing 2a around the hinge portion 2c. Thus, a user may open/close the housing 2. When the housing 2 is in an open state (as illustrated in FIG. 1), a user may play a game on the game device 1. In this state, the first display part 4 and the second display part 5 are vertically adjacent to each other. Alternatively, when the game device 1 is not used for playing a game, a user may place the housing 2 in a close state (not shown). In this state, the first display part 4 and the second display part 5 oppose each other.

Note that it is assumed in this embodiment that a user holds the game device 1 for use with the housing 2 placed in a state illustrated in FIG. 1, and hence, the first display part 4 and the second display part 5 are herein described to be vertically adjacent to each other. In the case where a user places the game device 1 on a flat plane like the top of a desk for use, however, the first display part 4 is disposed on the far side and the second display part 5 is disposed on the near side from a user. Alternatively, a user may use the game device laterally with the housing 2 rotated by approximately 90 degrees from the state of FIG. 1, and in this case, the first display part 4 and the second display part 5 are laterally adjacent to each other.

The processing unit 10 of the game device 1 reads a game program 101 from the secondary storage part 14 or the recording medium 9 and executes the program, so as to display images related to a game in the first display part 4 and the second display part 5. Furthermore, the processing unit 10 accepts user operations performed on the operation part 3, the first touch panel 11 and the second touch panel 12, so as to perform various determination processing related to the game in accordance with the accepted operations. On the basis of results of determination, the processing unit 10 performs processing for updating images in the first display part 4 and the second display part 5.

The game device 1 of this embodiment includes the two touch panels. The processing unit 10 performs processing for accepting an input operation for an absolute position of an image object displayed in the first display part 4 by using the first touch panel 11. Also, the processing unit 10 performs processing for accepting an input operation for positional change of an image object displayed in the first display part 4 by using the second touch panel 12. The input operation for positional change is, for example, what is called sliding input or flick input. The processing unit 10 further performs processing for accepting an input operation for an absolute position of and an input operation for positional change of an image object displayed in the second display part 5 by using the second touch panel 12.

Therefore, the processing unit 10 performs processing for specifying an absolute position in the first display device 4 on the basis of a detection result supplied from the first touch panel 11. When the first touch panel 11 and the first display part 4 have the same resolution, the processing unit 10 may define coordinates of a touch position detected by the first touch panel 11 as the absolute position in the first display part 4 corresponding to a target of the touching operation. On the contrary, when the first touch panel 11 and the first display part 4 have different resolutions, the processing unit 10 converts coordinates of a touch position detected by the first touch panel 11 into coordinates in the first display part 4, and defines the converted coordinates as the absolute position in the first display part 4 corresponding to the target of the touching operation.

Furthermore, the processing unit 10 performs processing for calculating a change in a touch position on the second touch panel 12 on the basis of detection results continuously or chronologically supplied from the second touch panel 12. In this case, the processing unit 10 calculates a quantity, a direction and/or a speed of change in the touch position on the second touch panel 12. The quantity of the change in a touch position may be calculated by calculating a distance between a starting point and an end point of the changed touch position. The direction of the change may be calculated by calculating a direction of a vector from the starting point to the end point of the touch position. The speed of the change may be calculated by calculating a quantity of the change caused per unit time. At this point, the unit time may be time defined in accordance with, for example, a clock period or a sampling period. The processing unit 10 performs various information processing related to a game in accordance with an absolute position in the first display part 4 accepted through the first touch panel 11 and a change in a touch position accepted through the second touch panel 12.

Next, details of user operations accepted through the first touch panel 11 and the second touch panel 12 in the game device 1 will be described by giving some examples.

In examples mentioned below, it is assumed that the game device 1 detects a touch position in the first display part 4 by using the first touch panel 11 provided in the display part. It is also assumed that the game device 1 detects a change in a touch position by using the second touch panel 12. As a result, a user may directly input a position in the first display part 4 by performing a touching operation on the first touch panel 11. A user may, for example, select an object such as an icon displayed at a touch position in the first display part 4. Furthermore, a user may input relative positional change by performing a touch position changing operation on the second touch panel 12. A user may perform an operation to, for example, move an object displayed in the display part in accordance with, for example, a quantity of change in a touch position.

### <Cursor Moving Operation>

The game device 1 of this embodiment displays, in the first display part 4, a cursor for use in selection of an image object and the like. Examples of the image object are a menu or an icon displayed in the first display part 4, and a character or an item to be controlled in a game. A user of the game device 1 may perform a cursor moving operation by a touching operation on the first touch panel 11 and a touch position changing operation on the second touch panel 12. Incidentally, a cursor herein means a pattern of an arrow or the like to be displayed to indicate a position corresponding to an operation target in a GUI (Graphical User Interface) environment using a pointing device.

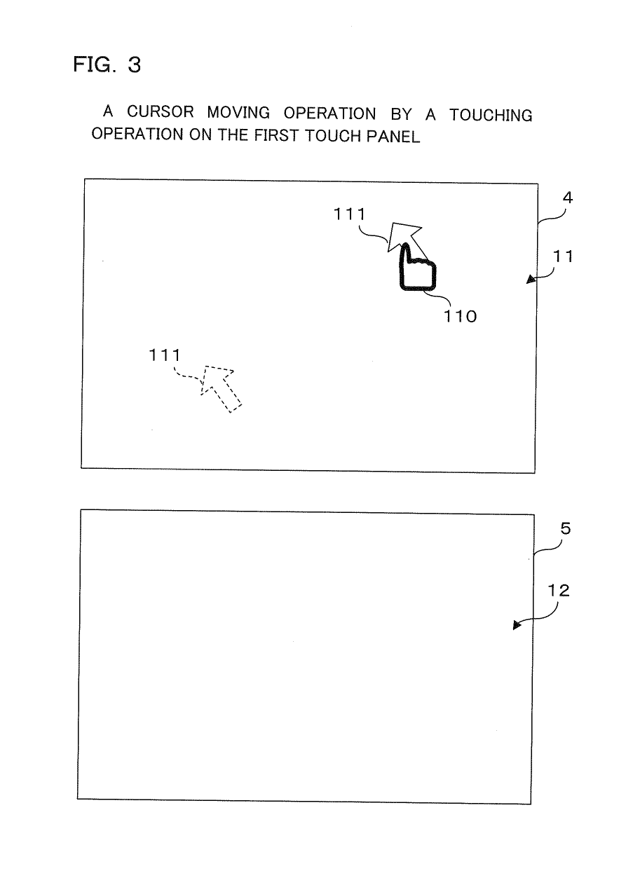

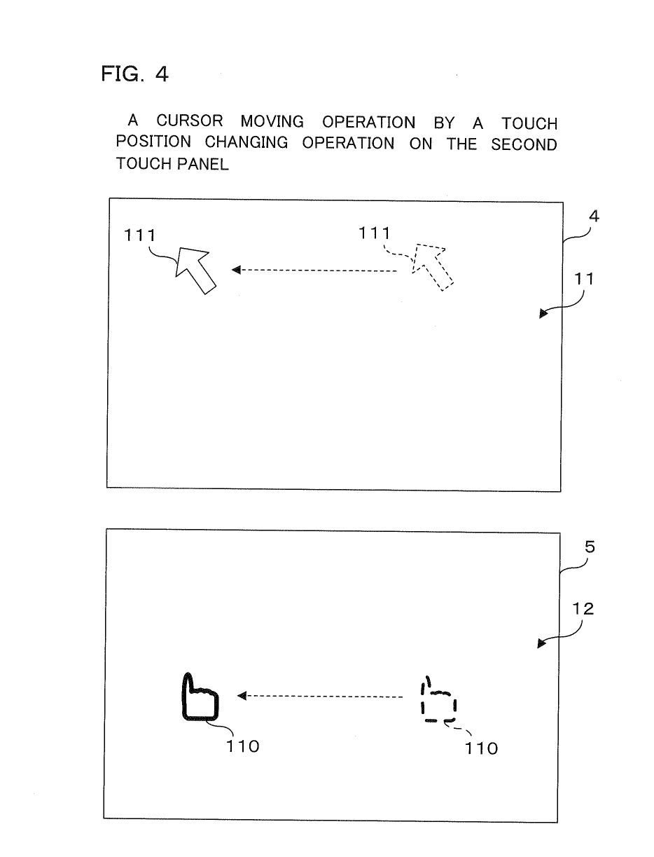

FIGS. 3 and 4 are schematic diagrams explaining the cursor moving operation. It is noted that the first display part 4 and the second display part 5 of the game device 1 are illustrated in FIGS. 3 and 4 with the other components such as the housing 2 and the operation part 3 omitted. Furthermore, a hand-shaped mark 110 illustrated with a thick line in FIGS. 3 and 4 corresponds to a touch position touched by a user.

A user may directly specify a display position of a cursor 111 in the first display part 4 by performing a touching operation on the first touch panel 11. In an example illustrated in FIG. 3, for example, a user performs a touching operation on an upper right portion in the first display part 4 while the cursor 111 is displayed in a lower left portion in the first display part 4 (as illustrated with a broken line arrow). In this case, a display position of the cursor 111 is changed from the lower left portion in the first display part 4 to a touch position 110 touched by the user (as illustrated with a solid line arrow). At this point, the processing unit 10 of the game device 1 performs processing for specifying a display position in the first display part 4 corresponding to the touch position 110 detected on the first touch panel 11 and displaying the cursor 111 in the specified position.

Furthermore, a user may move the cursor 111 in the first display part 4 by performing a touch position changing operation on the second touch panel 12. In an example illustrated in FIG. 4, for example, a user moves a touch position 110 from right to left on the second touch panel 12 while the cursor 111 is displayed in an upper right portion in the first display part 4 (as illustrated with a broken line arrow). In this case, the display position of the cursor 111 displayed in the first display part 4 is changed on the basis of the change in the touch position 110 on the second touch panel 12. The quantity and speed of movement of the cursor 111 should not always be the same as the quantity and speed of movement of the touch position 110 on the second touch panel 12. The direction of the movement of the cursor 111 is, however, substantially the same as the direction of the movement of the touch position 110 on the second touch panel 12.

In this case, the processing unit 10 of the game device 1 periodically acquires the touch position 110 on the second touch panel 12 and periodically calculates a change (at least a moving direction) in the touch position 110. Furthermore, the processing unit 10 determines the quantity, the direction and the like of movement of the cursor 111 corresponding to the calculated change, and periodically updates the display position of the cursor 111 in the first display par 4 for moving the cursor 111.

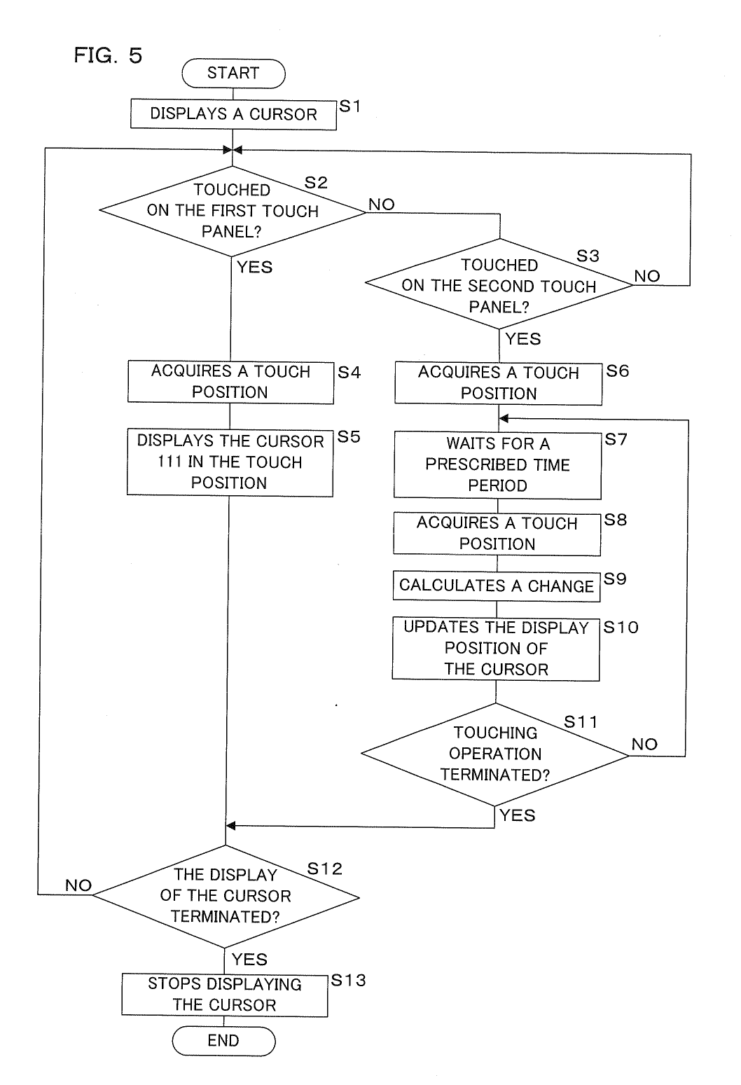

FIG. 5 is a flowchart illustrating procedures in cursor moving processing executed by the processing unit 10. First, the processing unit 10 of the game device 1 displays a cursor in the first display part 4 (step S1). The processing unit 10 determines whether or not there is a touch on the first touch panel 11 (step S2). When there is no touch on the first touch panel 11 (NO in step S2), the processing unit 10 determines whether or not there is a touch on the second touch panel 12 (step S3). When there is no touch on the second touch panel 12 (NO in step S3), the processing unit 10 returns the processing to step S2 and waits until there is a touch on the first touch panel 11 or the second touch panel 12.

When there is a touch on the first touch panel 11 (YES in step S2), the processing unit 10 acquires coordinate information and the like of a touch position on the basis of a detection result supplied from the first touch panel 11 (step S4). Subsequently, the processing unit 10 displays the cursor 111 in a position in the first display part 4 corresponding to the touch position on the first touch panel 11 (step S5) and advances the processing to step S12.

When there is a touch on the second touch panel 12 (YES in step S3), the processing unit 10 acquires a touch position on the basis of a detection result supplied from the second touch panel 12 (step S6). Subsequently, the processing unit 10 waits for a prescribed time period corresponding to, for example, a sampling period (step S7), and acquires a touch position on the second touch panel 12 after the prescribed time period (step S8). On the basis of the touch position s acquired before and after the prescribed time period, the processing unit 10 calculates a change, namely, the quantity, the direction, the speed and the like of the change, in the touch position on the second touch panel 12 (step S9). The processing unit 10 updates the display position of the cursor 111 for changing the display position of the cursor 111 displayed in the first display part 4 in accordance with the calculated change (step S10). Thereafter, the processing unit 10 determines whether or not a touching operation on the second touch panel 12 has been terminated (step S11). When the touching operation has not been terminated (NO in step S11), the processing unit 10 returns the processing to step S7, so as to repeatedly perform procedures for acquiring a touch position, updating the display position of the cursor 111 and the like. When the touching operation has been terminated, the processing unit 10 advances the processing to step S12.

Thereafter, the processing unit 10 determines whether or not there is a factor of unnecessity for displaying the cursor 111 as a result of switching of a game screen, a mode or the like, so as to determine whether or not the display of the cursor 111 is to be terminated (step S12). When it is determined that the display of the cursor 111 is not to be terminated (NO in step S12), the processing unit 10 returns the processing to step S2, so as to repeatedly perform the aforementioned procedures. When it is determined that the display of the cursor 111 is to be terminated (YES in step S12), the processing unit 10 stops displaying the cursor 111 (step S13) and terminates the cursor moving processing.

In this manner, the processing unit 10 of the game device 1 accepts a touching operation performed on the first touch panel 11 as specification of an absolute position in the first display part 4. Furthermore, the processing unit 10 displays a cursor 111 in a prescribed position in the first display part 4 corresponding to a touch position on the first touch panel 11. As a result, a user may intuitively specify a display position of the cursor 111 by touching an image displayed in the first display part 4. Furthermore, the processing unit 10 calculates a change in a touch position on the second touch panel 12 and moves the cursor 111 in the first display part 4 in accordance with the calculated change. As a result, a user may move the cursor 111 without degrading visibility of the first display part 4 because there is no need to touch the first display part 4 with a finger or the like for moving the cursor 111.

### <Icon Moving Operation>

The game device 1 of this embodiment displays a plurality of icons in the first display part 4 in order to accept, for example, selection of a game to be started or selection of a setting item of the game device 1. A user of the game device 1 selects a desired icon by touching an icon displayed in the first display part 4. Thus, the user may, for example, start a game or display a setting item correspondingly to the selected icon. Furthermore, a user may move (rearrange) a plurality of icons displayed in the first display part 4 by performing a touching operation for an absolute position on the first touch panel 11 and a touch position changing operation on the second touch panel 12.

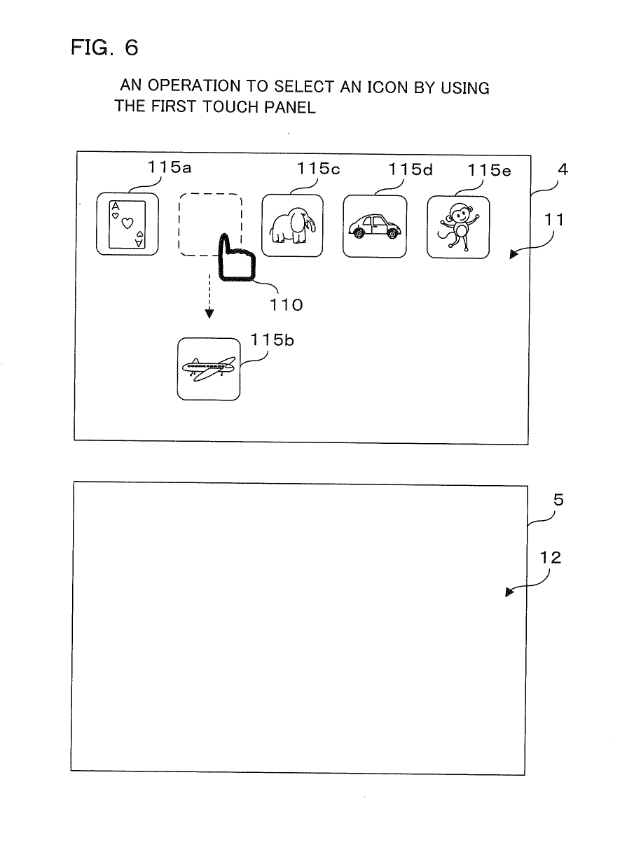

FIGS. 6 to 8 are schematic diagrams explaining an icon moving operation. Note that the first display part 4 and the second display part 5 of the game device 1 are illustrated in FIGS. 6 to 8 with the other components such as the housing 2 and the operation part 3 omitted. Furthermore, in FIGS. 6 to 8, a hand-shaped mark 110 illustrated with a thick line corresponds to a touch position touched by a user. Also, icons are illustrated as rectangular areas respectively having different pictures, patterns or the like.

The game device 1 displays, for example, five icons 115a to 115e arranged in one line in a horizontal direction in an upper portion of the first display part 4. After setting the game device 1 to a mode for rearranging the icons 115a to 115e, a user performs a touching operation for touching any of the icons 115a to 115e displayed in the first display part 4. Thus, the user may perform a selecting operation for selecting any of the icons 115a to 115e to be moved. When the user performs the touching operation on one of the icons 115a to 115e, the display position of said one of the icons 115a to 115e selected through the touching operation is moved downward (to be out of the line). In an example illustrated in FIG. 6, a user selects the second icon 115b from the left out of the five icons 115a to 115e displayed in one line. The display position of this icon 115b is moved downward.

In this case, the processing unit 10 of the game device 1 specifies a display position in the first display part 4 corresponding to a touch position 110 detected by the first touch panel 11. The processing unit 10 accepts one icon 115b displayed in the specified position as the icon 115b selected by the user. The processing unit 10 having accepted the selection of the icon 115b changes the display position of the selected icon 115b downward from the original position.

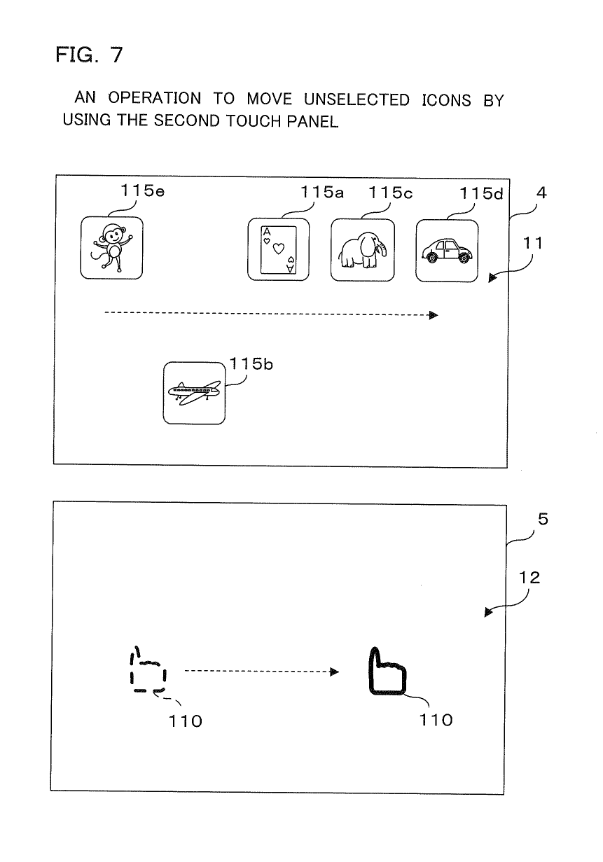

After performing the selecting operation for the icons 115a to 115e by using the first touch panel 11, the user performs an operation to change the touch position 110 on the second touch panel 12. Thus, the user may move the display positions of the other unselected icons 115a and 115c to 115e displayed in the first display part 4 laterally, namely, may perform what is called lateral scrolling. In an example illustrated in FIG. 7, for example, the user moves the touch position 110 from left to right on the second touch panel 12. Accordingly, the four unselected icons 115a and 115c to 115e displayed in the upper portion of the first display part 4 are scrolled in a left-to-right direction. In the scrolling from left to right, one of the icons 115a and 115c to 115e having been displayed on the right end of the line may be moved to be displayed on the left end of the line. Note that in the case where there are five or more icons and merely some of the icons are displayed in the first display part 4, hidden icons may be displayed in the first display part 4 as a result of the scrolling. Furthermore, in an original area where the selected second icon 115b has been displayed in the line of icons 115a to 115e, none of the unselected icons 115a and 115c to 115e is displayed during the scrolling of the unselected icons 115a and 115c to 115e.

In this case, the processing unit 10 of the game device 1 periodically acquires the touch position 110 on the second touch panel 12 so as to periodically calculate a change in the touch position 110 in the lateral direction. The processing unit 10 determines a moving direction and the like of the unselected icons 115a and 115c to 115e in accordance with the calculated change in the lateral direction, and moves the unselected icons 115a and 115c to 115e in the lateral direction in the first display part 4.

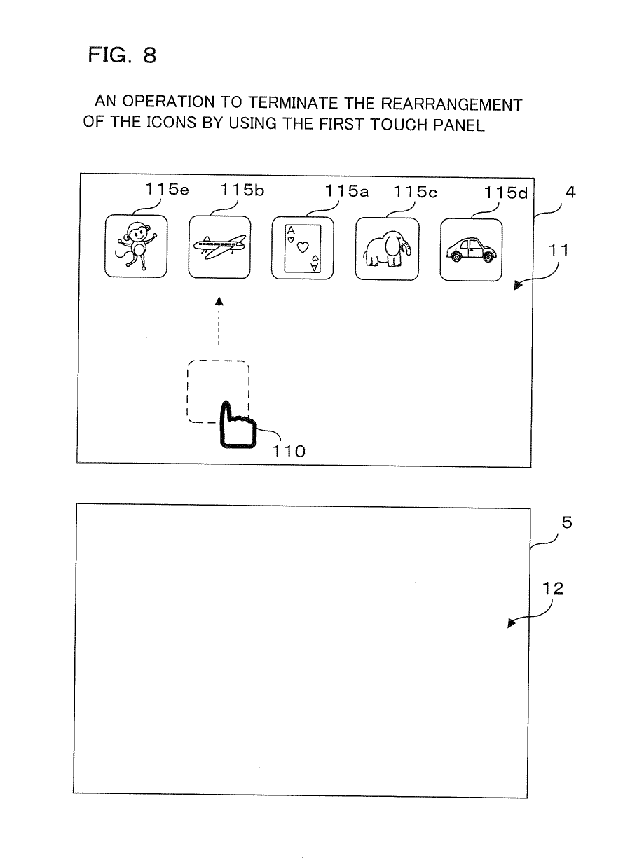

Thereafter, the user performs an operation to terminate the rearrangement of the icons 115a to 115e by performing, for example, a touching operation on the first touch panel 11. At this point, the processing unit 10 of the game device 1 moves the icon 115b, whose display position has been moved downward in the first display part 4, to the upper original position (see FIG. 8). Thus, the user may change an arranging order of the five icons 115a to 115e in the first display part 4 and cancel the mode of the game device 1 for rearranging the icons 115a to 115e.

It is noted that the operation to terminate the rearrangement may be an operation other than the touching operation on the first touch panel 11. The processing unit 10 may determine to terminate the rearrangement of the icons 115a to 115e when, for example, no touching operation has been performed either on the first touch panel 11 or on the second touch panel 12 for a prescribed or longer period of time. Alternatively, the processing unit 10 may determine to terminate the rearrangement of the icons 115a to 115e when, for example, a touch on the second touch panel 12 is removed. Alternatively, the processing unit 10 may determine to terminate the rearrangement of the icons 115a to 115e when, for example, an operation to change a touch position vertically is performed on the second touch panel 12.

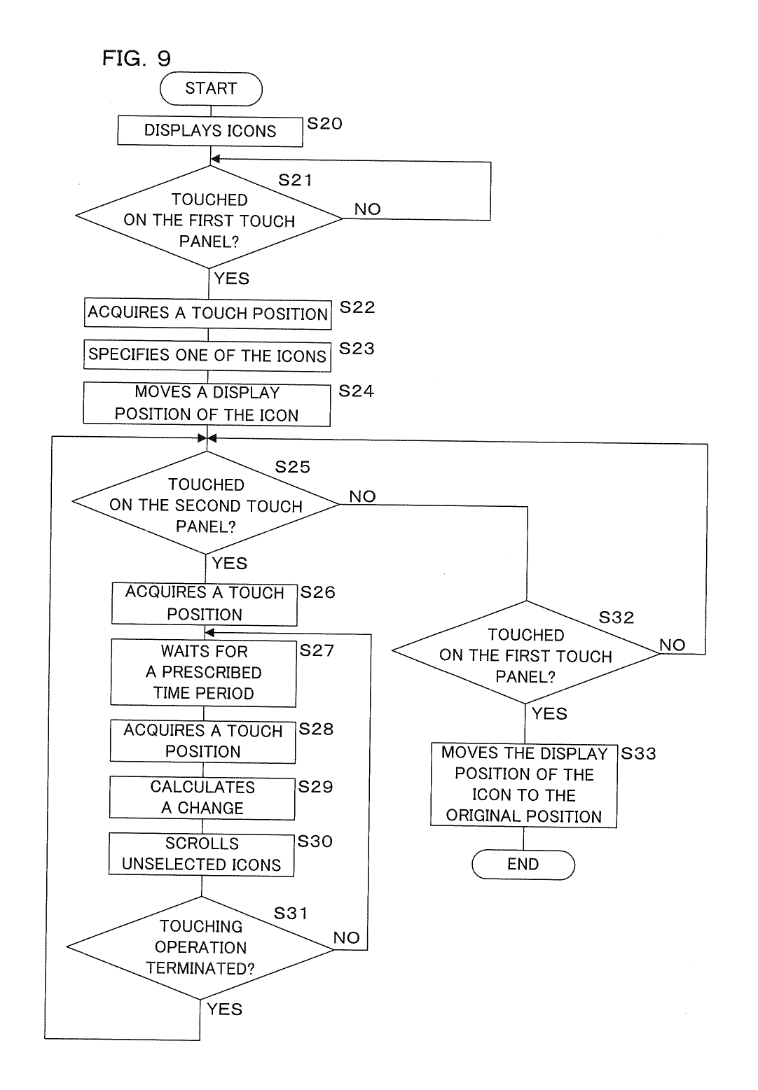

FIG. 9 is a flowchart illustrating procedures in icon moving processing executed by the processing unit 10. When the game device 1 is switched to the mode for rearranging the icons 115a to 115e, the processing unit 10 first displays the icons 115a to 115e in the first display part 4 (step S20). Subsequently, the processing unit 10 determines whether or not there is a touch on the first touch panel 11 (step S21). When there is no touch on the first touch panel 11 (NO in step S21), the processing unit 10 waits until there is a touch on the first touch panel 11. When there is a touch on the first touch panel 11 (YES in step S21), the processing unit 10 acquires coordinate information and the like of a touch position on the basis of a detection result supplied from the first touch panel 11 (step S22). The processing unit 10 accepts a selecting operation performed by a user for selecting one of the icons 115a to 115e to be selected by specifying one of the icons 115a to 115e displayed in the first display part 4 in a position corresponding to the acquired touch position (step S23). The processing unit 10 moves a display position of the icon specified out of the icons 115a to 115e to a direction away from a line of the plural icons 115a to 115e (that is, downward in FIG. 6) (step S24).

Subsequently, the processing unit 10 determines whether or not there is a touch on the second touch panel 12 (step S25). When there is a touch on the second touch panel 12 (YES in step S25), the processing unit 10 acquires a touch position on the basis of a detection result supplied from the second touch panel 12 (step S26). Thereafter, the processing unit 10 waits for a prescribed time period (step S27) and acquires a touch position on the second touch panel 12 after the prescribed time period (step S28). The processing unit 10 calculates a change in the touch position on the second touch panel 12 on the basis of the touch positions acquired before and after the prescribed time period (step S29). The processing unit 10 scrolls, in accordance with the calculated change, unselected icons 115 except for the selected icon 115 accepted to be selected through procedures of steps S21 to S24 (step S30). Thereafter, the processing unit 10 determines whether or not the touching operation on the second touch panel 12 has been terminated (step S31). When the touching operation has not been terminated (NO in step S31), the processing unit 10 returns the processing to step S27, so as to repeatedly perform procedures for acquiring a touch position, scrolling unselected icons 115 and the like. When the touching operation has been terminated (YES in step S31), the processing unit 10 returns the processing to step S25.

Furthermore, when it is determined in step S25 that there is no touch on the second touch panel 12 (NO in step S25), the processing unit 10 determines whether or not there is a touch on the first touch panel 11 (step S32). When it is determined that there is no touch on the first touch panel 11 (NO in step S32), the processing unit 10 returns the processing to step S25 and waits until there is a touch on the first touch panel 11 or the second touch panel 12. When there is a touch on the first touch panel 11 (YES in step S32), the processing unit 10 moves the display position of the icon 115 having been moved to be out of the line in step S24 to the original position (step S33), and terminates the icon moving processing.

In this manner, the processing unit 10 of the game device 1 accepts a selection of an icon 115 displayed in the first display part 4 through a touching operation performed on the touch panel 11. As a result, a user may intuitively select an icon 115 to be rearranged by directly touching any of a plurality of icons 115 displayed in the first display part 4. Furthermore, the processing unit 10 calculates a change in a touch position on the second touch panel 12 and moves unselected icons in accordance with the calculated change. As a result, a user may scroll the unselected icons 115 without degrading visibility of the first display part 4, and hence may rearrange the selected icon 115 in a desired position.

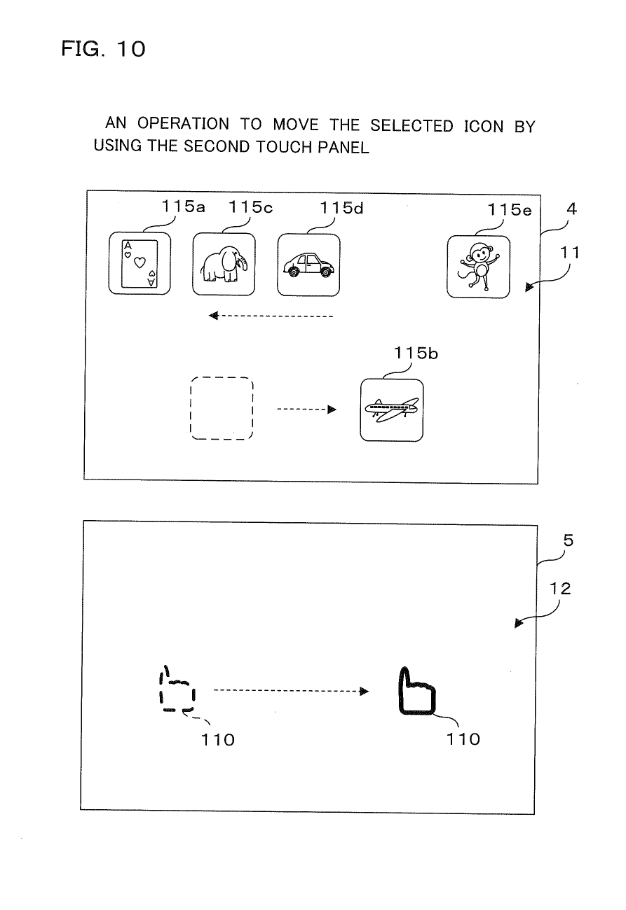

The processing unit 10 moves the icons 115 other than the icon 115 selected through the touching operation on the first touch panel 11, in accordance with the change in the touch position on the second touch panel 12 in the aforementioned example, which is not restrictive. FIG. 10 is a schematic diagram illustrating another example of the icon moving operation. In the example illustrated in FIG. 10, the processing unit 10 moves an icon 115b selected through the touching operation on the first touch panel 11 downward from the line of the plural icons 115a to 115e displayed in the upper portion of the first display part 4. Subsequently, the processing unit 10 moves the display position of the selected icon 115b from left to right in a lower portion of the first display part 4 in accordance with a left to right change in a touch position on the second touch panel 12. At this point, the processing unit 10 moves the unselected icons 115c and 115d in the opposite direction (i.e. from right to left) so that the selected icon 115b displayed in the lower portion may not be vertically adjacent to any of the unselected icons 115a and 115c to 115e displayed in the upper portion of the first display part 4. Thereafter, the user may perform an operation to terminate the movement of the icon 115b by performing, for example, a touching operation on the first touch panel 11.

Furthermore, although the icons 115 are described as a target of an operation performed by using the first touch panel 11 and the second touch panel 12 in the aforementioned example, the target is not limited to the icons. For example, when a list of a plurality of photographic images or the like are displayed in the first display part 4, the game device 1 may accept a selection of one of the photographic images in accordance with a touching operation performed on the first touch panel 11. Furthermore, the game device 1 may accept an operation to move a photographic image in accordance with a change in a touch position on the second touch panel 12. At this point, the game device 1 may move a selected photographic image or move unselected photographic images. Alternatively, the game device 1 may display a plurality of objects such as game characters in the first display part 4. In this case, the game device 1 may accept a selection of an object in accordance with a touching operation performed on the first touch panel 11 and accept an operation to move the selected object in accordance with a change in a touch position on the second touch panel 12. At this point, the game device 1 may move the selected character or may move a portion other than the selected character, such as a field on which the character is disposed.

### <Parameter Operation>

The game device 1 of this embodiment accepts setting of parameters (set values) such as a sound volume of a speaker, and brightness of the first display part 4 and the second display part 5. For this purpose, the game device 1 displays a plurality of parameter setting objects in the first display part 4. A user of the game device 1 may select a parameter to be set by performing a touching operation on any of the parameter setting objects displayed in the first display part 4. Furthermore, the user may change a parameter by performing a touch position changing operation on the second touch panel 12.

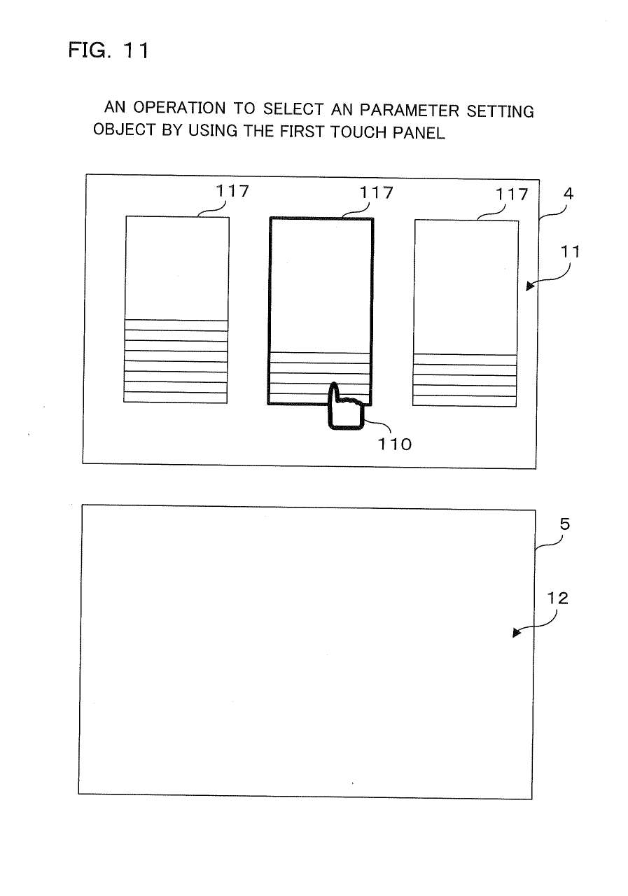

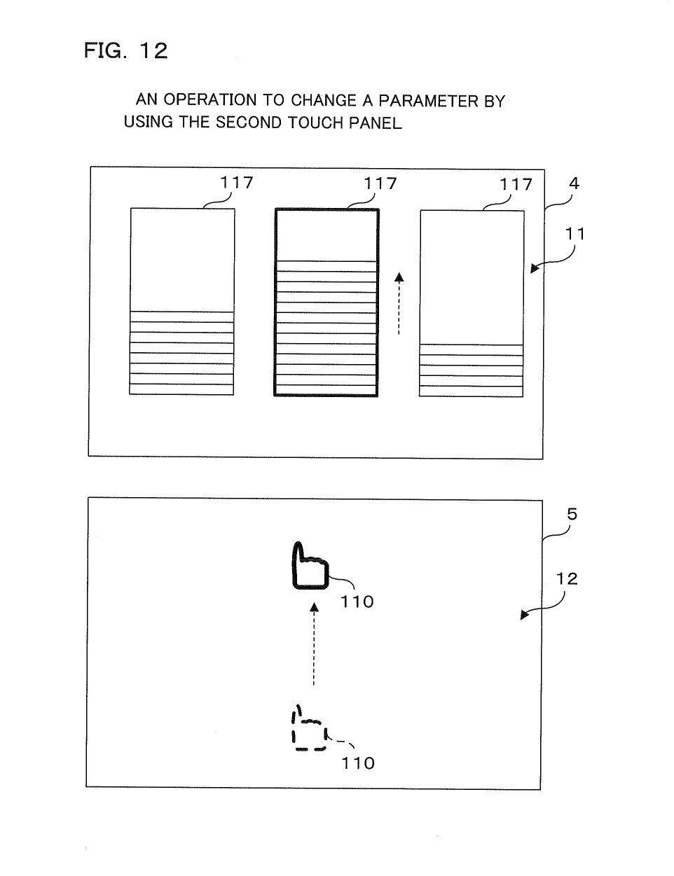

FIGS. 11 and 12 are schematic diagrams explaining a parameter setting operation. It is noted that the first display part 4 and the second display part 5 of the game device 1 are illustrated in FIGS. 11 and 12 with the other components such as the housing 2 and the operation part 3 omitted. Furthermore, a hand-shaped mark 110 illustrated with a thick line in FIGS. 11 and 12 corresponds to a touch position touched by a user. It is assumed that the game device 1 of this example displays, as parameter setting objects 117, indicators aligned horizontally in the first display part 4 to be vertically elongated/shortened in accordance with increase/decrease of the parameters.

A user may display, in the first display part 4, a setting screen in which the plural parameter setting objects 117 are aligned as illustrated in these drawings by switching the game device 1 to a parameter setting mode. The user may select any of the parameter setting objects 117 by performing a touching operation on any of the parameter setting objects 117 displayed in the first display part 4. A parameter setting object 117 selected by the user is highlighted by, for example, providing a thick border. In an example illustrated in FIG. 11, out of three parameter setting objects 117 displayed horizontally in alignment in the first display part 4, a user selects a parameter setting object 117 disposed in the center. The selected parameter setting object 117 is highlighted.

At this point, the processing unit 10 of the game device 1 acquires a touch position 110 as a detection result supplied from the first touch panel 11 and specifies a display position in the first display part 4 corresponding to the touch position 110. The processing unit 10 accepts one parameter setting object 117 displayed in the specified position as a parameter setting object 117 selected by the user. The processing part 10 having accepted the selection of the parameter setting object 117 highlights the selected parameter setting object 117.

After performing the selecting operation for the parameter setting objects 117 by using the first touch panel 11, the user performs an operation to change a touch position 110 on the second touch panel 12 such as an operation to move a touch position 110 in a vertical direction. Thus, the user may change a parameter corresponding to the selected parameter setting object 117. In an example illustrated in FIG. 12, a user moves the touch position 110 upward on the second touch panel 12. In accordance with this operation, the parameter is increased, and hence, the indicator of the parameter setting object 117 highlighted in the first display part 4 is elongated.

At this point, the processing unit 10 of the game device 1 periodically acquires the touch position 110 on the second touch panel 12 so as to periodically calculate a change in the vertical direction of the touch position 110. The processing unit 10 determines the quantity of increase/decrease of the parameter in accordance with the quantity of the calculated change in the vertical direction. The processing unit 10 elongates/shortens the indicator of the parameter setting object 117 displayed in the first display part 4 in accordance with the increase/decrease of the parameter. Furthermore, the processing unit 10 performs processing for, for example, increasing/decreasing an output volume of a speaker in accordance with the increase/decrease of the parameter.

Note that the parameter changing operation performed by using the second touch panel 12 is not limited to the vertical movement of the touch position 110. In the case where, for example, indicators elongating/shortening laterally are used, the game device 1 may employ a structure in which a parameter changing operation is accepted through lateral movement of a touch position 110. Alternatively, in the case where the second touch panel 12 is capable of detecting two or more touch positions, the game device 1 may employ a structure in which a parameter is increased through an operation to increase a distance between two touch positions and is decreased through an operation to decrease the distance.

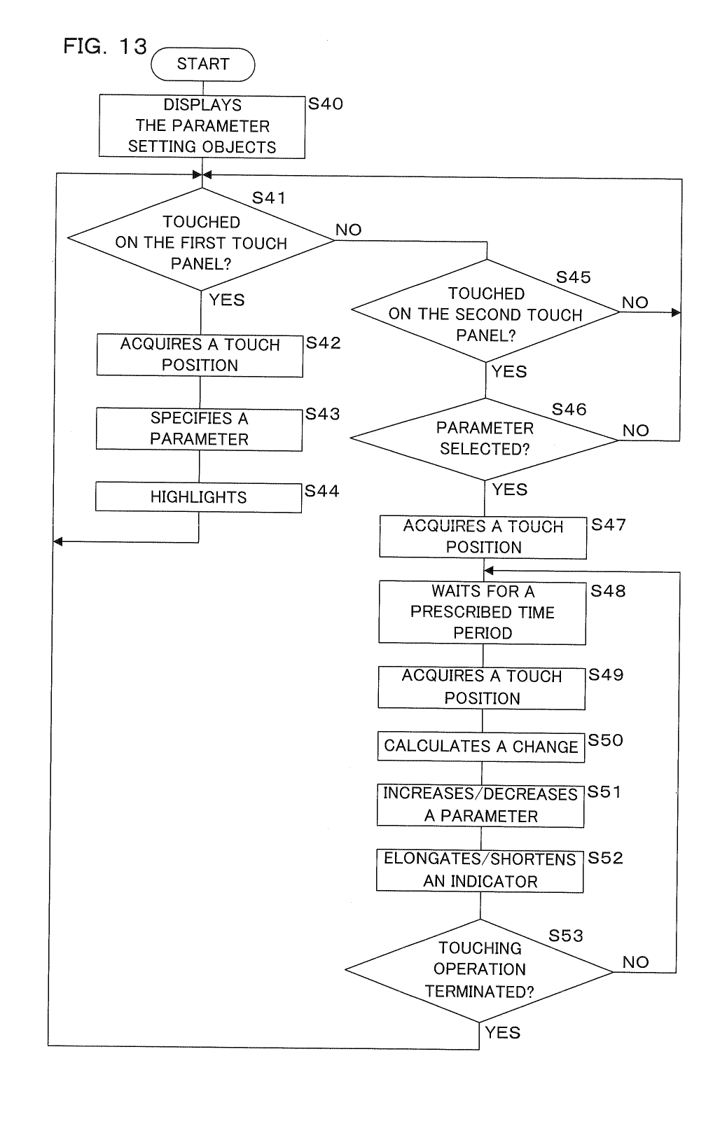

FIG. 13 is a flowchart illustrating procedures in parameter setting processing executed by the processing unit 10. When the game device 1 is switched to a mode for setting a parameter, the processing unit 10 first displays the parameter setting objects 117 in the first display part 4 (step S40). Subsequently, the processing unit 10 determines whether or not there is a touch on the first touch panel 11 (step S41). When there is a touch on the first touch panel 11 (YES in step S41), the processing unit 10 acquires coordinate information and the like of a touch position on the basis of a detection result supplied from the first touch panel 11 (step S42). The processing unit 10 accepts a selection, made by a user, of a parameter to be set by specifying a parameter, that is, a parameter setting object 117, corresponding to the touch position (step S43). The processing unit 10 hightights the specified parameter setting object 117 (step S44) and returns the processing to step S41.

When there is no touch on the first touch panel 11 (NO in step S41), the processing unit 10 determines whether or not there is a touch on the second touch panel 12 (step S45). When there is a touch on the second touch panel 12 (YES in step S45), the processing unit 10 determines whether or not a parameter to be set has been selected through a touching operation on the first touch panel 11 (step S46). When there is no touch on the second touch panel 12 (NO in step S45), or when a parameter to be set has not been selected (NO in step S46), the processing unit 10 returns the processing to step S41. Thereafter, the processing unit 10 waits until there is a touch on the first touch panel 11 or the second touch panel 12.

When a parameter to be set has been selected (YES in step S46), the processing unit 10 acquires a touch position on the basis of a detection result supplied from the second touch panel 12 (step S47). Subsequently, the processing unit 10 waits for a prescribed time period (step S48), and acquires a touch position on the second touch panel 12 after the prescribed time period (step S49). The processing unit 10 calculates a change in the touch position on the second touch panel 12 on the basis of the touch positions acquired before and after the prescribed time period (step S50). The processing unit 10 increases/decreases a parameter corresponding to the parameter setting object 117 accepted to be selected in procedures of steps S41 to S44 in accordance with the calculated change (step S51). Furthermore, the processing unit 10 elongates/shortens an indicator corresponding to the parameter setting object 117 (step S52). Thereafter, the processing unit 10 determines whether or not the touching operation on the second touch panel 12 has been terminated (step S53). When the touching operation has not been terminated (NO in step S53), the processing unit 10 returns the processing to step S48, so as to repeatedly perform procedures for acquiring a touch position, increasing/decreasing a parameter and the like. When the touching operation has been terminated (YES in step S53), the processing unit 10 returns the processing to step S41. The processing unit 10 performs this processing until the game device 1 is switched to a mode other than the mode for setting a parameter.

In this manner, the processing unit 10 of the game device 1 accepts the selection of a parameter setting object 117 to be set through the touching operation on the first touch panel 11. As a result, a user may intuitively select a parameter to be set by directly touching one of a plurality of parameter setting objects 117 displayed in the first display part 4. Furthermore, the processing unit 10 calculates a change in a touch position on the second touch panel 12 and changes the parameter in accordance with the calculated change. In addition, the processing unit 10 elongates/shortens an indicator corresponding to the parameter setting object 117. As a result, a user may change the selected parameter without degrading the visibility of the first display part 4. Accordingly, the user may easily and reliably check increase/decrease of the parameter by using the parameter setting object 117.

Note that although the game device 1 displays the indicator as the parameter setting object 117 in the aforementioned example, the parameter setting object is not limited to the indicator. The parameter setting object 117 may be any of various objects other than those described above such as a counter showing a numerical value of a parameter. Furthermore, the game device 1 may increase/decrease, in step S51, a parameter corresponding to a parameter setting object 117 other than the parameter setting object 117 accepted to be selected in the procedures of steps S41 to S44. Moreover, the game device 1 may elongate/shortens an indicator corresponding to the alternate setting object 117 in step S52.

### <Graphics Operation>

When the game device 1 of this embodiment executes a game program 101 for, for example, drawing a picture, it displays graphics or letters drawn by a user in the first display part 4. The user of the game device 1 may select a target graphic by performing a touching operation on a graphic displayed in the first display part 4. Furthermore, the user may perform a graphic deforming operation or the like through a touch position changing operation on the second touch panel 12.

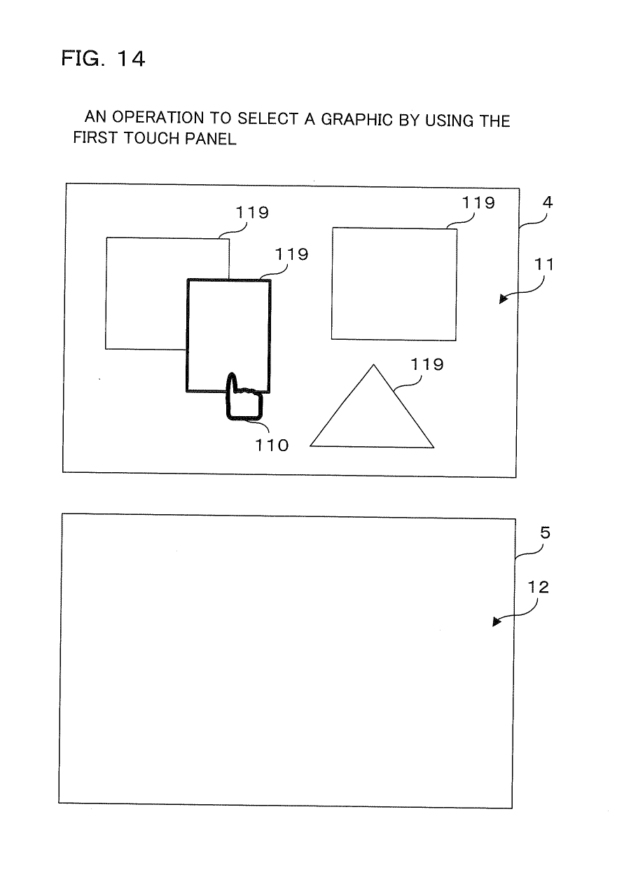

FIGS. 14 to 17 are schematic diagrams explaining a graphics operation. It is noted that the first display part 4 and the second display part 5 of the game device 1 are illustrated in FIGS. 14 to 17 with the other components such as the housing 2 and the operation part 3 omitted. Furthermore, a hand-shaped mark 110 illustrated with a thick line in FIGS. 14 to 17 corresponds to a touch position touched by a user. It is assumed in this example that a user performs operations to enlarge, rotate and move a graphic 119 such as a rectangle and a triangle having been drawn on the first touch panel 11.

A user may select a target graphic 119 by performing a touching operation on one or a plurality of graphics 119 displayed in the first display part 4. The graphic 119 selected by the user is highlighted by, for example, providing a thick border. In an example illustrated in FIG. 14, a user selects a rectangle disposed in the center out of three rectangles and one triangle displayed in the first display part 4, and this graphic 119 is highlighted.

At this point, the processing unit 10 of the game device 1 acquires a touch position 101 on the basis of a detection result supplied from the first touch panel 11, so as to specify a display position in the first display part 4 corresponding to the touch position 110. The processing unit 10 accepts one graphic 119 displayed in the specified position as a target graphic 119 selected by the user. The processing unit 10 having accepted the selection of the graphic 119 highlights the selected graphic 119.

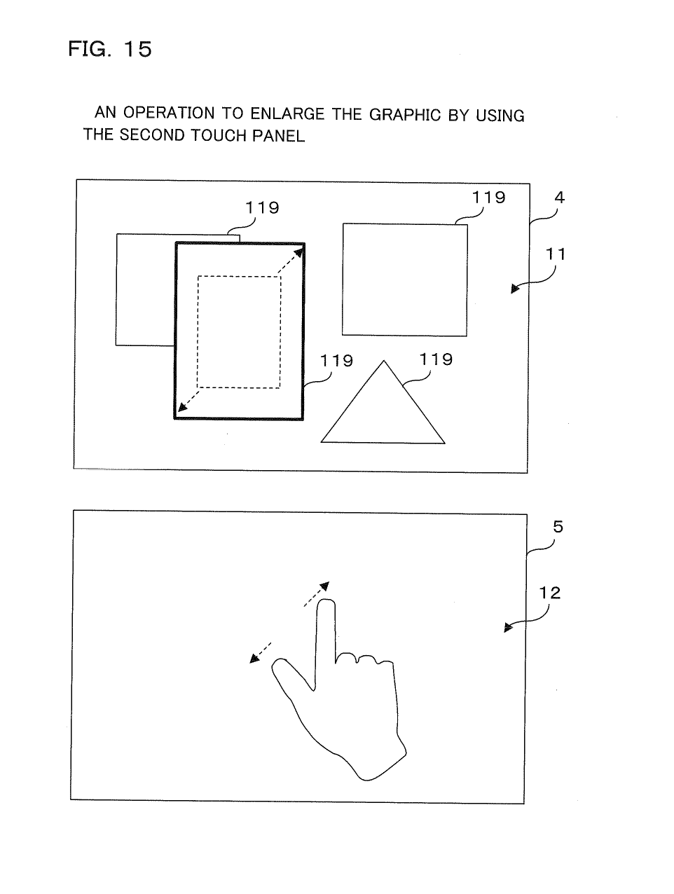

After selecting the target graphic 119 by using the first touch panel 11, the user performs an operation to change a touch position 110 on the second touch pane 12. Thus, the user may perform various operations on the selected graphic 119. In an example illustrated in FIG. 15, it is assumed that the second touch panel 12 employs the structure in which two or more touch positions may be detected. The user may enlarge the graphic 119 by performing an operation to increase a distance between two touch positions and may shrink the graphic 119 by performing an operation to reduce the distance. At this point, the processing unit 10 of the game device 1 determines an enlarging/shrinking direction for the graphic 119 in accordance with the direction of change in the distance between the two touch positions and determines the quantity of enlarging/shrinking the graphic 119 in accordance with the quantity of change in the distance.

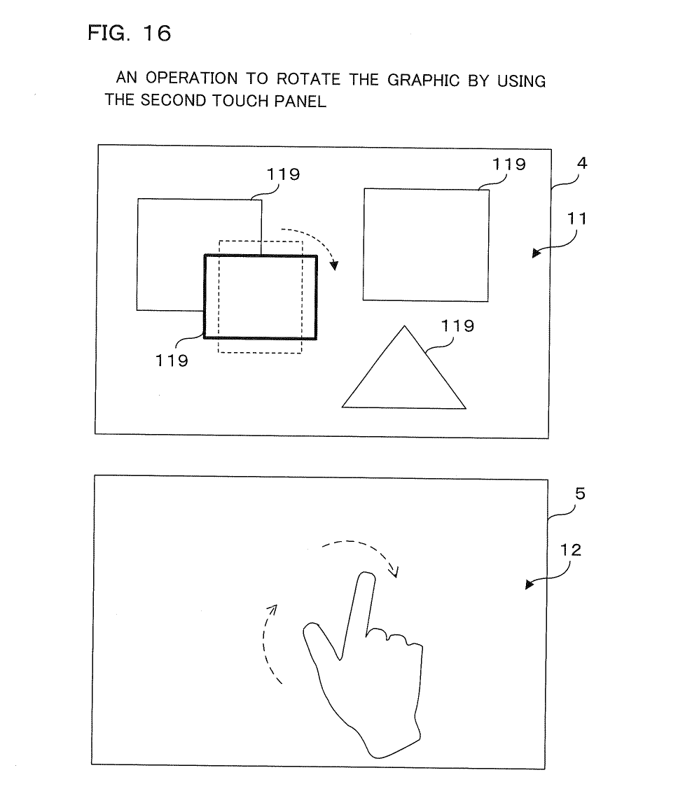

In an example illustrated in FIG. 16, a user may rotate the selected graphic 119 by performing an operation to rotate two touch positions rightward (clockwise). At this point, the processing unit 10 of the game device 1 calculates a change in the direction of a vector connecting two touch positions and determines the direction and the quantity of rotation of the graphic 119 in accordance with the calculated change.

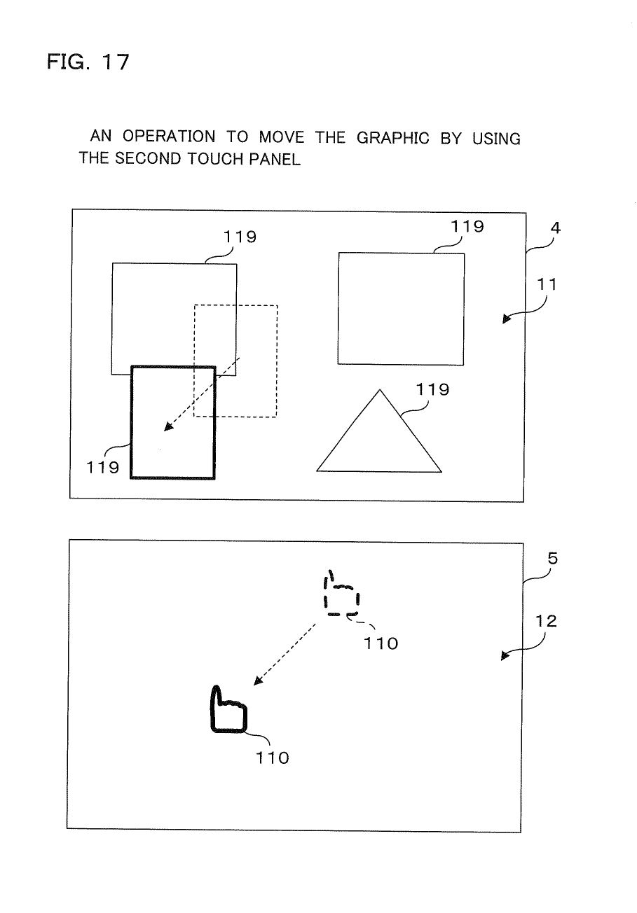

In an example illustrated in FIG. 17, a user linearly moves a touch position 110 on the second touch panel 12. In accordance with the linear movement, the selected graphic 119 is moved. At this point, the processing unit 10 of the game device 1 calculates the direction and the quantity of change in the touch position 110 on the second touch panel 12. The processing unit 10 determines the direction of the movement of the graphic 119 in accordance with the direction of the change and determines the quantity of the movement of the graphic 119 in accordance with the quantity of the change.

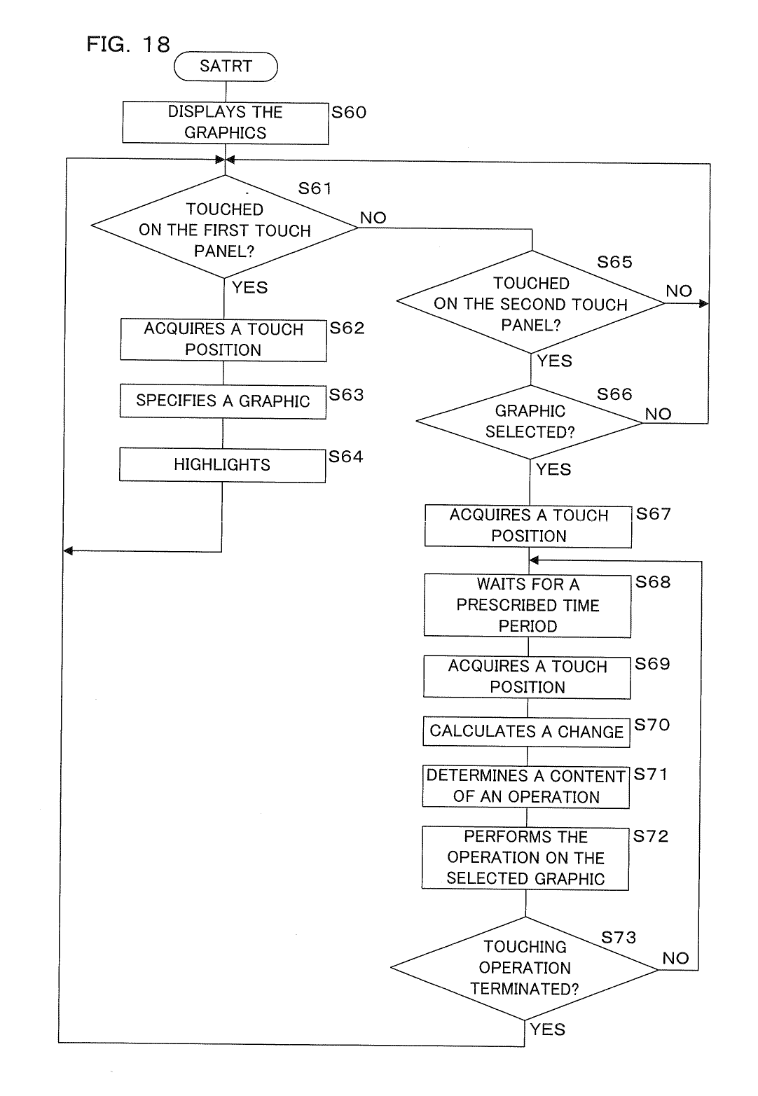

FIG. 18 is a flowchart illustrating procedures in graphics operation processing executed by the processing unit 10. The processing unit 10 of the game device 1 first displays the graphics 119 in the first display part 4 (step S60). Next, the processing unit 10 determines whether or not there is a touch on the first touch panel 11 (step S61). When there is a touch on the first touch panel 11 (YES in step S61), the processing unit 10 acquires coordinate information and the like of a touch position on the basis of a detection result supplied from the first touch panel 11 (step S62). The processing unit 10 accepts selection, made by a user, of a graphic 119 by specifying a graphic 119 corresponding to the acquired touch position (step S63). The processing unit 10 highlights the specified graphic (step S64) and returns the processing to step S61.

When there is no touch on the first touch panel 11 (NO in step S61), the processing unit 10 determines whether or not there is a touch on the second touch panel 12 (step S65). When there is a touch on the second touch panel 12 (YES in step S65), the processing unit 10 determines whether or not a target graphic 119 has been selected through a touching operation performed on the first touch panel 11 (step S66). When there is no touch on the second touch panel 12 (NO in step S65), or when a target graphic 119 has not been selected (NO in step S66), the processing unit 10 returns the processing to step S61. Thereafter, the processing unit 10 waits until there is a touch on the first touch panel 11 or the second touch panel 12.

When a target graphic 119 has been selected (YES in step S66), the processing unit 10 acquires a touch position on the basis of a detection result supplied from the second touch panel 12 (step S67). Subsequently, the processing unit 10 waits for a prescribed time period (step S68), and acquires a touch position on the second touch panel 12 after the prescribed time period (step S69). The processing unit 10 calculates a change in the touch position on the second touch panel 12 on the basis of the touch positions acquired before and after the prescribed time period (step S70).

In accordance with the calculated change, the processing unit 10 determines a content (enlargement/shrinkage, rotation, movement or the like) of an operation to be performed on the graphic 119 (step S71). In the case where there are a plurality of touch positions on the second touch panel 12, for example, the processing unit 10 determines to perform an enlarging/shrinking operation on the graphic 119. Alternatively, in the case where a touch position 110 is moved circularly on the second touch panel 12, for example, the processing unit 10 determines to perform an operation to rotate the graphic 119. Alternatively, in the case where a touch position 110 is linearly moved on the second touch panel 12, for example, the processing unit 10 determines to perform an operation to move the graphic 119.

The processing unit 10 performs the operation determined in step S71 on the selected graphic 119 in accordance with the change calculated in step S70 (step S72). Thereafter, the processing unit 10 determines whether or not the touching operation on the second touch panel 12 has been terminated (step S73). When the touching operation has not been terminated (NO in step S73), the processing unit 10 returns the processing to step S68, so as to repeat the procedures for acquiring a touch position, performing a graphics operation and the like. When the touching operation has been terminated (YES in step S73), the processing unit 10 returns the processing to step S61. The processing unit 10 executes this processing, for example, until the game program 101 for drawing a picture is terminated.

In this manner, the processing unit 10 of the game device 1 accepts a selection of a target graphic 119 through a touching operation performed on the first touch panel 11. As a result, a user may intuitively select a target graphic 119 by directly touching any of a plurality of graphics 119 displayed in the first display part 4. Furthermore, the processing unit 10 calculates a change in a touch position on the second touch panel 12 and performs an operation to, for example, enlarge/shrink, rotate or move the graphic 119 in accordance with the calculated change. As a result, a user may perform a desired operation on the selected graphic 119 without degrading the visibility of the first display part 4.

The operation to be performed on a graphic 119 by using the second touch panel 12 is not limited to the aforementioned operations to enlarge/shrink, rotate and move the graphic. Also, methods for performing the enlarging/shrinking, rotating and moving operations for the graphic 119 by using the second touch panel 12 are not limited to those described above. For example, the processing unit 10 may enlarge a graphic 119 when a touch position 110 is moved in a specific direction on the second touch panel 12 and may shrink the graphic 119 when the touch position 110 is moved in an opposite direction. Alternatively, the processing unit 10 may enlarge or shrink a graphic 119 by using a touch position 110 on the first touch panel 11 as a base point and in accordance with the direction and the quantity of movement of a touch position 110 on the second touch panel 12.

Furthermore, the processing unit 10 may further calculate a change in a touch position 110 on the first touch panel 11 so as to perform an operation to change the display in the first display part 4 in accordance with the calculated change. In this case, the operation to change a touch position on the first touch panel 11 may be, for example, an operation to enlarge/shrink, rotate or move the whole image displayed in the first display part 4. Also in this case, the touch position changing operation on the second touch panel 12 may be an operation to enlarge/shrink, rotate or move a specific selected graphic 119. At this point, the operation performed on a graphic 119 by using the first touch panel 11 is selection of the graphic 119 through a touching operation. Moreover, the game device 1 may perform, in step S72, an operation to enlarge/shrink, rotate or move a graphic 119 other than the graphic 119 accepted to be selected in procedures of steps S62 to S64.

### <Game Control Operation>

The game device 1 of this embodiment displays, when a game program 101 of, for example, an action game is executed, images related to the game in the first display part 4 and the second display part 5. A user may perform game control operations through a touching operation on the first touch panel 11 and a touch position changing operation on the second touch panel 12.

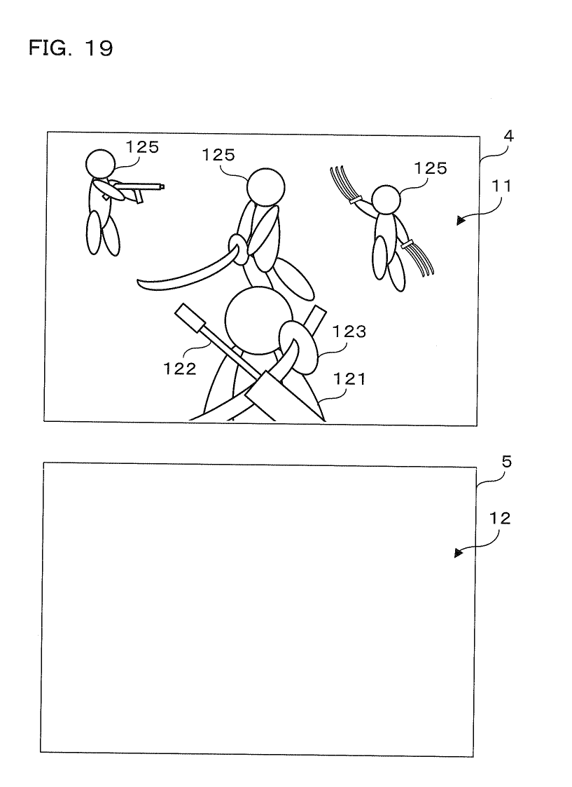

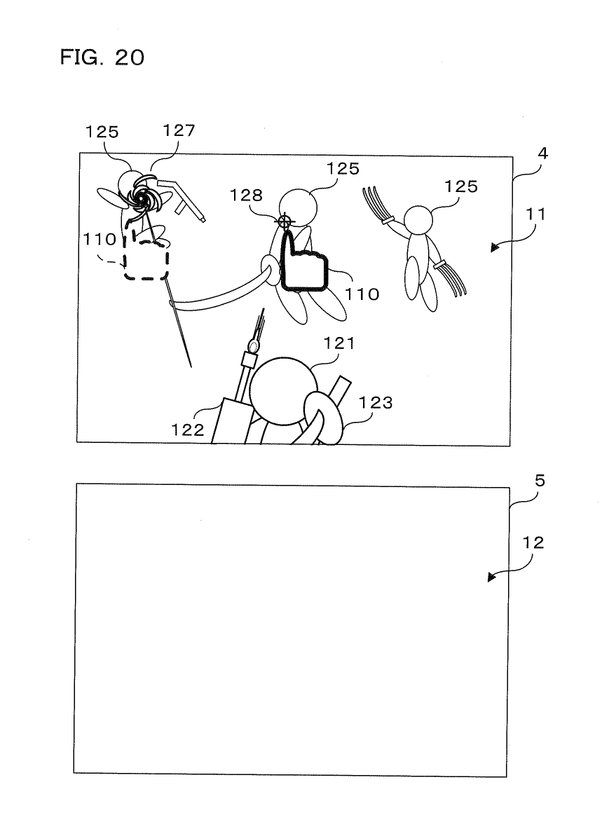

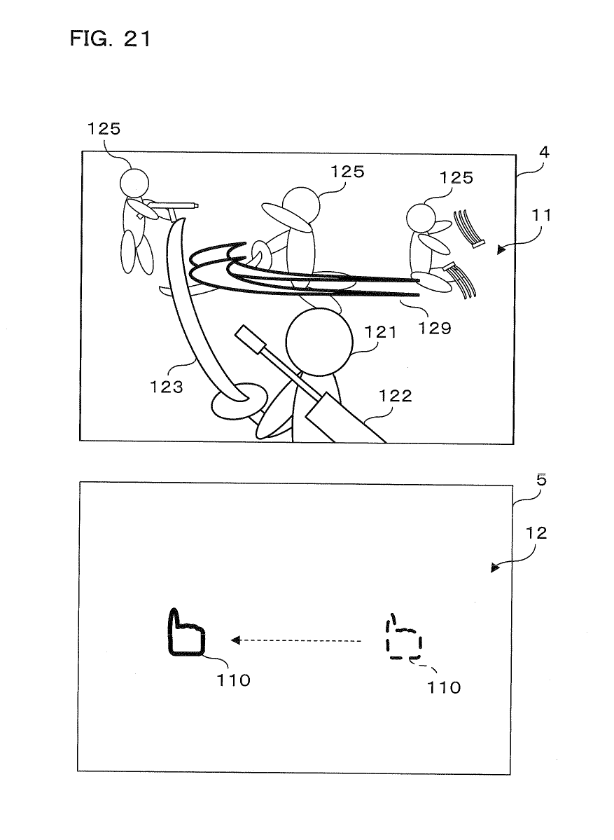

FIGS. 19 to 21 are schematic diagrams explaining the game control operations. It is noted that the first display part 4 and the second display part 5 of the game device 1 are illustrated in FIGS. 19 to 21 with the other components such as the housing 2 and the operation part 3 omitted. Furthermore, a hand-shaped mark 110 illustrated with a thick line in FIGS. 20 and 21 corresponds to a touch position touched by a user.

A game described in this example is an action game in which a humanoid self-character 121 controlled by a user fights against one or a plurality of enemy characters 125. In an example illustrated in FIG. 19, a back view of the self-character 121 is displayed in a substantially center of the lower part of the first display part 4 of the game device 1. Furthermore, a plurality of enemy characters 125 are displayed above the self-character 121 in the first display part 4. The self-character 121 is displayed larger than the enemy characters 125, so as to express distances between the self-character 121 and the enemy characters 125. Furthermore, the self-character 121 holds a shooting weapon 122 such as a gun or a bow and a close combat weapon 123 such as a sword or an axe for attacking the enemy characters 125.

A user may make an attack with the shooting weapon 122 by performing a touching operation on the first touch panel 11. In this case, a touch position 110 on the first touch panel 11 corresponds to a target point (an aiming point) of the attack with the shooting weapon 122 on a game screen displayed in the first display part 4. In an example illustrated in FIG. 20, three enemy characters 125 are displayed laterally in one line in the first display part 4. After making an attack against the left-side enemy character 125 with the shooting weapon 122, the user makes an attack against the center enemy character 125. The attack hits the left-side enemy character 125, and an effect image 127 corresponding to the hit attack is displayed over the enemy character 125. The attack against the center enemy character 125 is now under determination, and an aiming image 128 is displayed in the first display part 4 correspondingly to a touch position 110 touched by the user.

In this case, the processing unit 10 of the game device 1 acquires a touch position 110 on the basis of a detection result supplied from the first touch panel 11. The processing unit 10 specifies a display position in the first display part 4 corresponding to the acquired touch position 110 and accepts the specified position as an attack point of the shooting weapon 122. The processing unit 10 displays the aiming image 128 in the specified position. Furthermore, the processing unit 10 determines whether or not the attack with the shooting weapon 122 has succeeded depending upon whether or not the enemy character is present in the specified position. When it is determined that the attack has succeeded, the processing unit 10 displays the effect image 127 in a position corresponding to the touch position 110 in the first display part 4. At this point, the processing unit 10 causes the attacked enemy character 125 to make an attacked action or the like. Alternatively, when it is determined that the attack has failed, the processing unit 10 displays an effect image (not shown) corresponding to the failure of the attack.

Furthermore, the user may make an attacking action with the close combat weapon 123 by controlling an action of the self-character 121 through a touch position changing operation on the second touch panel 12. The close combat weapon 123 is a weapon that may be used for attacking an enemy character present within an attack range when it is grasped and swung by the self-character 121. In the case where a user performs a touch position changing operation on the second touch panel 12, the self-character 121 makes an action to swing the close combat weapon 123 in accordance with the direction, the quantity and the speed of change in a touch position, so as to attack the enemy character 125. In an example illustrated in FIG. 21, a user performs a touch position changing operation on the second touch panel 12 horizontally from right to left. In accordance with this operation, the self-character 121 makes an action to swing the close combat weapon 123 horizontally from right to left, and an effect image 129 corresponding to the attack range is displayed in the first display part 4.

At this point, the processing unit 10 of the game device 1 periodically acquires a touch position 110 on the second touch panel 12. The processing unit 10 periodically calculates the direction, the quantity and the speed of change in the acquired touch position 110 so as to accept an attack operation performed by the user as an action of the self-character 121. The processing unit 10 determines a direction in which the self-character 121 swings the close combat weapon 123 in accordance with the direction of the change in the touch position 110. The processing unit 10 determines a distance in which the self-character 121 swings the close combat weapon 123 in accordance with the quantity of the change in the touch position 110. Also, the processing unit 10 determines a speed with which the self-character 121 swings the close combat weapon 123 in accordance with the speed of the change in the touch position 110. Thus, the processing unit 10 determines an attack range in accordance with the direction and the distance of swinging the close combat weapon 123 and determines attack power in accordance with the speed of swinging the close combat weapon 123.

The processing unit 10 determines whether or not the attack with the close combat weapon 123 has succeeded depending upon whether or not the enemy character 125 is present within the determined attack range. Furthermore, the processing unit 10 performs processing for displaying the effect image 129 in the attack range in the first display part 4. When it is determined that the attack is successful, the processing unit 10 causes the attacked enemy character 125 to make an attacked action or the like. When it is determined that the attack is unsuccessful, the processing unit 10 may perform processing for, for example, causing the enemy character 125 to make an action to avoid the attack with the close combat weapon 123.

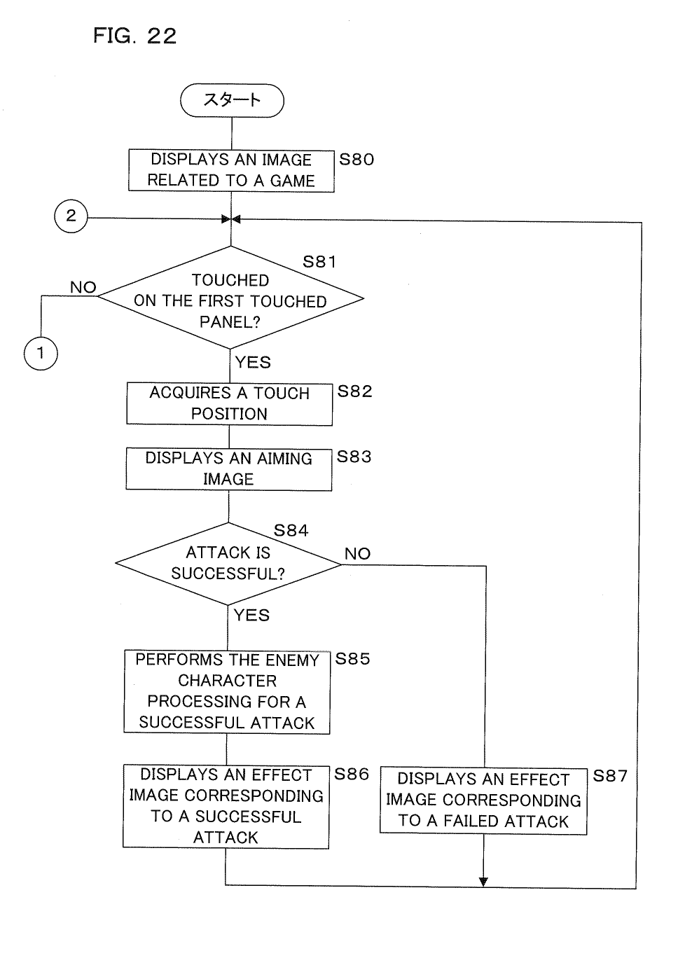

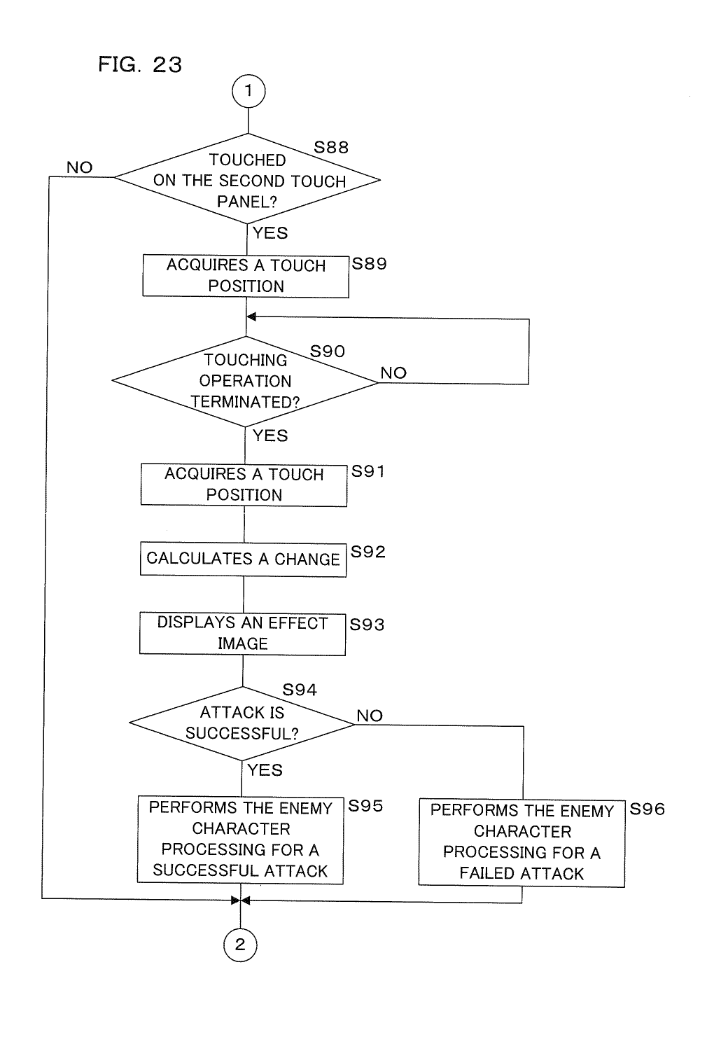

FIGS. 22 and 23 are flowcharts illustrating procedures in game control operation accepting processing executed by the processing unit 10. The processing unit 10 of the game device 1 first displays an image related to a game in the first display part 4 (step S80). Subsequently, the processing unit 10 determines whether or not there is a touch on the first touch panel 11 (step S81). When there is a touch on the first touch panel 11 (YES in step S81), the processing unit 10 acquires coordinate information and the like of a touch position on the basis of a detection result supplied from the first touch panel 11 (step S82). Thus, the processing unit 10 accepts an attack position of the shooting weapon 122, namely, an attack target position. The processing unit 10 displays an aiming image 128 at a position in the first display part 4 corresponding to the touch position (step S83).

Subsequently, the processing unit 10 determines whether or not the attack with the shooting weapon 122 is successful depending upon whether or not the enemy character 125 is present at the touch position (step S84). When it is determined that the attack is successful (YES in step S84), the processing unit 10 performs enemy character processing for a successful attack by, for example, causing the enemy character 125 to make an action indicating that it is attacked (step S85). Furthermore, the processing unit 10 displays an effect image 127 corresponding to the successful attack at the position in the first display part 4 corresponding to the touch position (step S86), and returns the processing to step S81. When it is determined that the attack is failed (NO in step S84), the processing unit 10 displays an effect image corresponding to a failed attack (step S87) and returns the processing to step S81.

When there is no touch on the first touch panel 11 (NO in step S81), the processing unit 10 determines whether or not there is a touch on the second touch panel 12 (step S88). When there is no touch on the second touch panel 12 (NO in step S88), the processing unit 10 returns the processing to step S81, and waits until there is a touch on the first touch panel 11 or the second touch panel 12. When there is a touch on the second touch panel 12 (YES in step S88), the processing unit 10 acquires a touch position on the basis of a detection result supplied from the second touch panel 12 (step S89). Subsequently, the processing unit 10 determines whether or not the touching operation on the second touch panel 12 has been terminated (step S90), and when the touching operation has not been terminated (NO in step S90), the processing unit 10 waits until the touching operation is terminated.

When the touching operation on the second touch panel 12 has been terminated (YES in step S90), the processing unit 10 acquires a final touch position on the second touch panel 12 (step S91). On the basis of a first touch position and the final touch position on the second touch panel 12, the processing unit 10 calculates a change in the touch position on the second touch panel 12 (step S92). Thus, the processing unit 10 accepts an attack operation of the self-character 121. The processing unit 10 determines an attack range of the close combat weapon 123 in accordance with the calculated change, and displays an effect image 129 corresponding to this attack range in the first display part 4 (step S93).

Subsequently, the processing unit 10 determines whether or not the attack with the close combat weapon 123 is successful depending upon whether or not the enemy character 125 is present within the attack range of the close combat weapon 123 (step S94). When it is determined that the attack is successful (YES in step S94), the processing unit 10 performs the enemy character processing for a successful attack by, for example, causing the enemy character 125 to make an attacked action (step S95), and returns the processing to step S81. When it is determined that the attack is failed (NO in step S94), the processing unit 10 performs the enemy character processing for a failed attack by, for example, causing the enemy character 125 to make an action to avoid the attack (step S96), and returns the processing to step S81. The processing unit 10 continuously performs the processing described so far until the game program 101 is terminated.

In this manner, the processing unit 10 of the game device 1 accepts specification of an attack position with the shooting weapon 122 through a touching operation on the first touch panel 11. As a result, a user may intuitively attack the enemy character 125 corresponding to an attack target with the shooting weapon 122 by directly touching the enemy character 125 displayed in the first display part 4. Furthermore, the processing unit 10 calculates a change in a touch position on the second touch panel 12. The processing unit 10 accepts an operation to input the direction, the distance, the speed and the like with which the self-character 121 swings the close combat weapon 123 in accordance with the calculated change. As a result, the user may intuitively make an attack with the close combat weapon 123 by using the self-character 121 without degrading the visibility of the first display part 4.

It is noted that game screens illustrated in FIGS. 19 to 21 are merely exemplary but are not restrictive. Furthermore, although the game device 1 performs the processing for attacking with the shooting weapon 122 in accordance with a touching operation on the first touch panel 11, this attacking processing is not restrictive. The game device 1 may perform, for example, processing for causing the self-character 121 to make an action to stab an enemy character with the close combat weapon 123 in accordance with a touching operation on the first touch panel 11. Alternatively, the game device 1 may perform processing with a touch position on the first touch panel 11 regarded as a stabbing attack position. Furthermore, the game device 1 performs the processing for attacking with the close combat weapon 123 in accordance with a touch position changing operation on the second touch panel 12, which is not restrictive. The game device 1 may perform, for example, processing for causing the self-character 121 to make a moving, avoiding or defending action in accordance with a touch position changing operation on the second touch panel 12.

Moreover, although the game device 1 is described to execute the game program 101 of an action game, this game program is not restrictive. The game device 1 may perform similar processing even in executing a game program 101 of a game other than the action game. The game device 1 may execute information processing related to a game in accordance with a touch position on the first touch panel 11 and a change in a touch position on the second touch panel 12.

The game device 1 according to the embodiment described so far executes information processing related to objects or the like displayed in the first display part 4 in accordance with a touch position on the first touch panel 11 and a change in a touch position on the second touch panel 12. Owing to this configuration, the game device 1 may attain high user-friendliness because a user may perform intuitive operations by using the first touch panel 11 and the second touch panel 12. Furthermore, since the first display part 4 of the game device 1 is never covered with a finger when a user performs a touch position changing operation, the visibility of the first display part 4 may be prevented from being degraded by the operation.

Although the portable game device 1 is exemplarily described as the information processing system or the information processor in this embodiment, the application of this embodiment is not limited to the portable game device 1. A similar configuration is applicable to any device such as a cellular phone, a smartphone, a tablet terminal, a notebook computer or a game console as far as it includes a display part such as a liquid crystal display or the like and a touch panel. The appearance of the game device 1 illustrated in FIG. 1 is merely exemplary and another appearance may be employed.

Although the game device 1 includes the first touch panel 11 and the second touch panel 12 (i.e., the first display part 4 and the second display part 5) vertically adjacent to each other, this positional relationship between them is not restrictive. For example, the first touch panel and the second touch panel may be laterally adjacent to each other. Furthermore, although the game device 1 includes the first touch panel 11 disposed in an upper portion and the second touch panel 12 disposed in a lower portion, this arrangement of the touch panels is not restrictive. The game device 1 may employ a structure in which the first touch panel 11 is disposed in the lower portion with the second touch panel 12 disposed in the upper portion.

Moreover, the first touch panel 11 and the second touch panel 12 may be physically one touch panel. In this case, the area of one touch panel may be appropriately divided, for example, so as to use an upper half area of the touch panel as the first touch panel and use a lower half area thereof as the second touch panel. Although images to be displayed in the second display part 5 of the game device 1 are not particularly described in this embodiment, various images may be displayed in the second display part 5. Furthermore, although the second touch panel 12 is provided in the second display part 5, this position of the second touch panel 12 is not restrictive. The second touch panel 12 may be provided in a portion out of the display part such as a portion on the housing 2.

### (Modification 1)

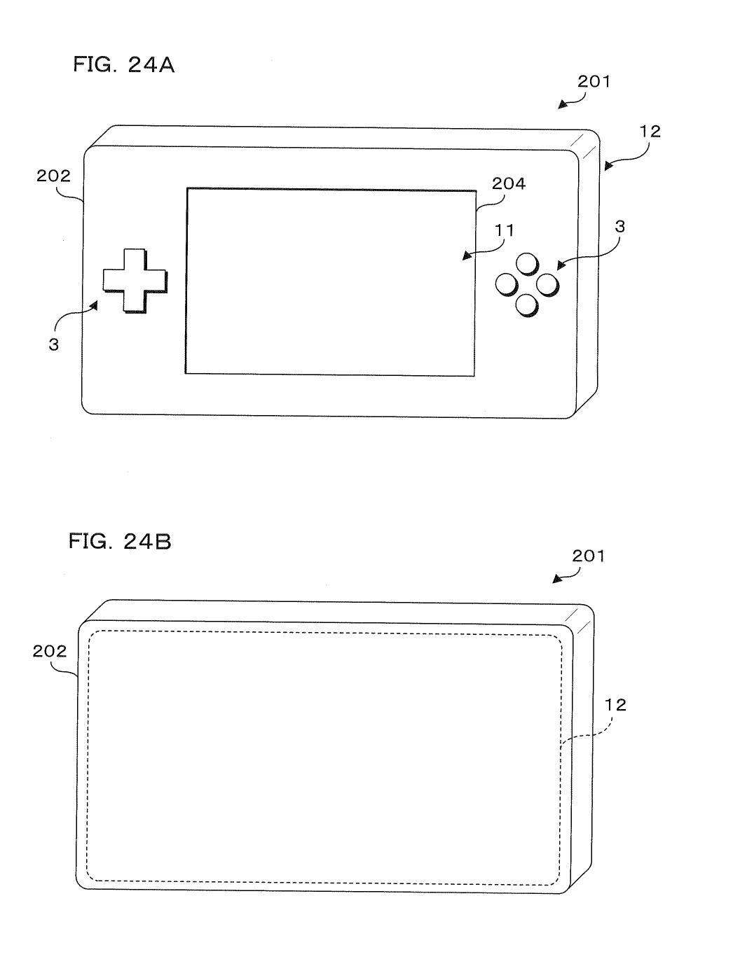

FIGS. 24A and 24B are schematic diagrams illustrating the appearance of a game device 201 according to Modification 1, and specifically, FIG. 24A illustrates a front face side of the game device 201 and FIG. 24B illustrates a rear face side thereof. The game device 201 according to Modification 1 includes a housing 202 in a flat substantially rectangular parallelepiped shape. A substantially rectangular display part 204 is provided in substantially the center of the housing 202, and operation parts 3 are provided on both right and left sides of the display part. The game device 201 includes a first touch panel 11 covering the display part 204. The game device 201 further includes a second touch panel 12 covering a part or the whole of a rear face of the housing 2 (as illustrated with a broken line in FIG. 24B).

The game device 201 according to Modification 1 executes information processing related to objects or the like displayed in the display part 204 in accordance with a touch position on the first touch panel 11 and a change in a touch position on the second touch panel 12.

The game device 201 of Modification 1 thus employs a structure in which the second touch panel 12 is provided on the rear face of the housing 202 so as to have the first touch panel 11 and the second touch panel 12 disposed on faces opposite to each other. Owing to this structure, a user may perform an operation using the second touch panel 12 while grasping the game device 201, and hence, the user-friendliness of the game device 201 may be further improved.

Note that the aforementioned game device 1 of FIG. 1 may employ a structure in which the first housing 2a and the second housing 2b may be unfolded by 360 degrees, namely, they may be folded with both the first touch panel 11 of the first housing 2a and the second touch panel 12 of the second housing 2b exposed to the outside. When this structure is employed, the game device 1 may be similar to the game device 201 of Modification 1. In this case, since the first touch panel 11 is positioned on a rear face of the housing 2, it is necessary to exchange the functions between the first touch panel 11 (the first display part 4) and the second touch panel 12 (the second display part 5).

The game device, for example, of FIG. 1 may employ the following structure: The first housing 2a provided with the operation part 3, the first display part 4, the first touch panel 11 and the like are disposed in a lower portion with the second housing 2b provided with the second display part 5, the second touch panel 12 and the like disposed in an upper portion. The second housing 2b connected to the first housing 2a with the hinge portion 2c may be rotated by approximately 360 degrees toward a rear face side of the first housing 2a. When the second housing 2b is rotated by 360 degrees toward the rear face side of the first housing 2a, the first display part 4 and the first touch panel 11 are disposed on a face opposite to a face where the second display part 5 and the second touch panel 12 are disposed. Note that the second display part 5 may not be provided in the second housing 2b in this case. Furthermore, in accordance with the positional relationship between the first housing 2a and the second housing 2b, the functions of the first display part 4 and the first touch panel 11 and the functions of the second display part 5 and the second touch panel 12 may be dynamically switched.

### (Modification 2)

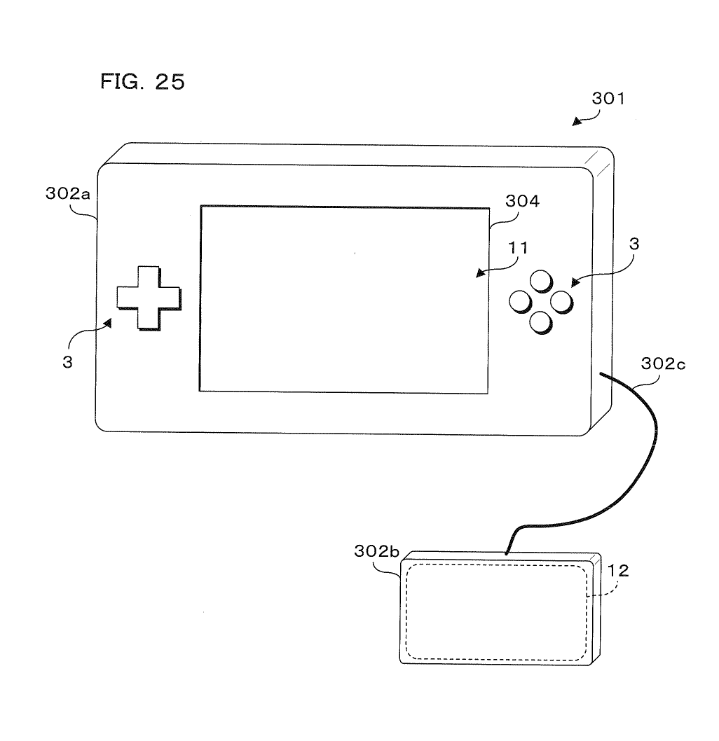

FIG. 25 is a schematic diagram illustrating the appearance of a game device 301 according to Modification 2. The game device 301 of Modification 2 includes a first housing 302a and a second housing 302b connected to each other through a communication cable 302c. The communication cable 302c may be detached from the first housing 302a. The first housing 302a of the game device 301 is in a flat substantially rectangular parallelepiped shape, and a display part 304 is provided in substantially the center of a front face thereof with operation parts 3 provided on both right and left sides of the display part 304. The game device 301 further includes a first touch panel 11 covering the display part 304.

The second housing 302b of the game device 301 is in a flat substantially rectangular parallelepiped shape smaller than the first housing 302a. The game device 301 further includes a second touch panel 12 covering a part or the whole of a front face of the second housing 302b (as illustrated with a broken line in FIG. 25). Information on a touch position detected by the second touch panel 12 is transferred as an analog or digital electric signal from the second housing 302b to the first housing 302a through the communication cable 302c. A processing unit 10, a primary storage part 13, a second storage part 14 and the like illustrated in FIG. 2 are provided inside the first housing 302a. The processing unit 10 having acquired a detection result of the second touch panel 12 through the communication cable 302 calculates a change in a touch position and executes information processing in accordance with the calculated change.

In this manner, the game device 301 of Modification 2 employs a structure in which the first touch panel 11 and the second touch panel 12 are respectively provided in different housings. When this structure is employed, for example, a device including one touch panel may be provided with a second touch panel as optional equipment. Note that although the first housing 302a and the second housing 302b are wire connected in this modification, the connection is not limited to wired communication. The game device 301 may employ a structure in which a detection result of the second touch panel 12 of the second housing 302b is transmitted to the first housing 302a through wireless communication.

### (Modification 3)

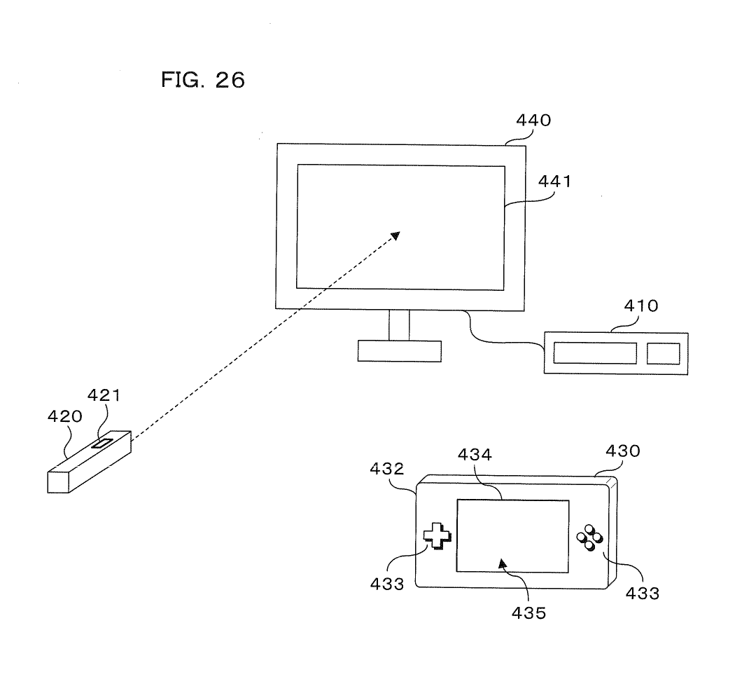

FIG. 26 is a schematic diagram illustrating the appearance of a game system according to Modification 3. The game system of Modification 3 includes a stationary-type game device main body 410, a first controller 420 and a second controller 430. The game device main body 410 includes a processing unit for executing information processing related to a game, a primary storage part and a secondary storage part for storing a program, data and the like, a wireless communication part for wirelessly transmitting/receiving information, a recording medium loading part for loading a recording medium in which a game program is recorded, and the like. The game device main body 410 is connected to a display device 440 such as a liquid crystal display through a cable such as an image signal line or a sound signal line, so that images and sounds related to a game may be output by the display device 440. The display device 440 displays an image related to a game in a display part 441 in accordance with a signal input from the game device main body 410.

The first controller 420 and the second controller 430 are used by a user in operations performed in playing a game, and transmit/receive information to/from the game device main body 410 through wireless communication. The first controller 420 includes a rod-shaped housing that may be grasped with one hand by a user, and an operation part 421 composed of a plurality of switches and the like provided on the housing. The first controller 420 may be used for inputting a position in the display part 441 by performing an operation with the operation part 421 with a tip portion of the housing directed to the display part 441 of the display device 440. In other words, the first controller 420 may be used as a pointing device. The first controller 420 transmits information on its own position, direction and the like to the game body main body 410 through the wireless communication. Thus, the processing unit of the game device main body 410 calculates an absolute position in the display part 441 pointed out by the first controller 420.

The second controller 430 includes a housing 432 in a flat substantially rectangular parallelepiped shape. The housing 432 includes a display part 434 in a substantially rectangular shape provided in substantially the center of a front face thereof, and operation parts 433 provided on both right and left sides of the display part. The second controller 430 further includes a touch panel 435 covering the display part 434. The second controller 430 transmits contents of operations performed in the operation part 433 and information on a touch position on the touch panel 435 and the like to the game device main body 410 through the wireless communication. Furthermore, the second controller 430 displays an image in the display part 434 on the basis of image information wirelessly transmitted from the game device main body 410.

In the game system of Modification 3, the processing unit of the game device main body 410 accepts an input from the first controller 420 as an input of an absolute position in the display part 441 of the display device 440. Furthermore, the processing unit of the game device main body 410 calculates a change in a touch position on the touch panel 435 of the second controller 430 and executes information processing for objects or the like displayed in the display part 441 of the display device 440 in accordance with the calculated change in the touch position.

In this manner, in the game system of Modification 3, the display part 441 of the display device 440 used for displaying an object or the like corresponding to an operation target is not provided with a touch panel. In the game system of Modification 3, the first controller 420 is used as a pointing device, and an input of a position in the display part 441 is accepted by the processing unit of the game device main body 410. Even when a touch panel cannot be provided in a display part, similar operations to those of the game device 1 of the aforementioned embodiment may be realized by accepting an input of a position in the display part by using a pointing device other than a touch panel.

Although the game system of this modification includes two controllers, that is, the first controller 420 and the second controller 430, the number of controllers is not limited to two. For example, the game system may include merely one controller out of the first controller 420 and the second controller 430, for example, by providing a touch panel in the first controller 420 or by providing the second controller 430 with a function of a pointing device. Furthermore, although the touch panel 435 is provided on the display part 434 of the second controller 430, this position of the touch panel is not restrictive. The touch panel 435 may be provided in, for example, the housing 432 without providing the display part 434 in the second controller 430.

In the aforementioned embodiment, an input of a touch position is detected by using a touch panel provided in a display part or a pointing device and a change in a touch position is detected by a different touch panel, so that information processing may be executed on the basis of results of these detections. Therefore, since the display part is never covered with a finger in performing a touch position changing operation, the display part may be prevented from being degraded in visibility due to a touching operation, and high user-friendliness with a touch panel may be attained.

Note that it should be understood that an element or the like herein mentioned in a singular form following “a” or “an” includes concept of a plural form.

What is claimed is:

1. An information processing system comprising:
a display part that displays an image;
a first touch panel that is provided in the display part and detects a touch position;
a second touch panel that detects a touch position;
a change calculating part that calculates a change in the touch position on the second touch panel; and
an information processing part that executes information processing in accordance with the touch position detected by the first touch panel and the change calculated by the change calculating part.

2. The information processing system according to claim 1,
wherein the change calculating part calculates at least one of a direction, a quantity and a speed of the change in the touch position on the second touch panel.

3. The information processing system according to claim 1,
wherein one or a plurality of objects are displayed in the display part,
the information processing system further comprises a selection operation accepting part that accepts a selection of an object displayed in the display part in accordance with the touch position detected by the first touch panel, and
the information processing part executes, in accordance with the change calculated by the change calculating part, information processing on the object accepted to be selected by the selection operation accepting part.

4. The information processing system according to claim 1,
wherein one or a plurality of objects are displayed in the display part,
the information processing system further comprises a selection operation accepting part that accepts a selection of an object displayed in the display part in accordance with the touch position detected by the first touch panel, and
the information processing part executes, in accordance with the change calculated by the change calculating part, information processing on an object other than the object accepted to be selected by the selection operation accepting part.

5. The information processing system according to claim 3,
wherein the objects are icons,
the selection operation accepting part accepts the selection of an icon, and
the information processing part executes information processing for changing a display position of the icon in accordance with the change calculated by the change calculating part.

6. The information processing system according to claim 4,
wherein the objects are icons,
the selection operation accepting part accepts the selection of an icon, and
the information processing part executes information processing for changing a display position of the icon in accordance with the change calculated by the change calculating part.

7. The information processing system according to claim 1,
wherein one or a plurality of setting objects respectively corresponding to settings in the information processing executed by the information processing part and used in operations to change the corresponding settings are displayed in the display part,
the information processing system further comprises a selection operation accepting part that accepts a selection of a setting corresponding to a setting object displayed in the display part in accordance with the touch position detected by the first touch panel, and
the information processing part executes information processing for changing the setting in accordance with the change calculated by the change calculating part.

8. The information processing system according to claim 3,
wherein the information processing part executes information processing for deforming the object in accordance with the change calculated by the change calculating part.

9. The information processing system according to claim 4,
wherein the information processing part executes information processing for deforming the object in accordance with the change calculated by the change calculating part.

10. The information processing system according to claim 1,
wherein the information processing part displays an object at the touch position detected by the first touch panel in the display part and executes information processing for changing a display position of the object in accordance with the change calculated by the change calculating part.

11. The information processing system according to claim 10,
wherein the object is a cursor.

12. The information processing system according to claim 1,
wherein an image including one or a plurality of objects related to a game is displayed in the display part,
the information processing system further comprises:
a target position accepting part that accepts the touch position detected by the first touch panel as a target position of a game control operation; and
an operation accepting part that accepts an operation related to an action of an object included in the image in accordance with the change calculated by the change calculating part, and
the information processing part executes information processing related to the game in accordance with the target position accepted by the target position accepting part and the operation accepted by the operation accepting part.

13. The information processing system according to claim 1,
wherein the information processing part executes information processing related to a game for attacking one or a plurality of objects displayed in the display part, and
the information processing system further comprises:
an attack position accepting part that accepts a specification of an attack position in accordance with the touch position detected by the first touch panel; and
an attack operation accepting part that accepts an operation related to an attack action in accordance with the change calculated by the change calculating part.

14. The information processing system according to claim 13,
wherein the attack position accepting part accepts the specification of the attack position of an attack with a shooting weapon, and
the information processing part executes information processing for determining whether or not the attack against an object is successful in accordance with the attack position accepted by the attack position accepting part.

15. The information processing system according to claim 13,
wherein the attack operation accepting part accepts the operation related to the attack action with a close combat weapon, and
the information processing part executes information processing for determining whether or not the attack against an object is successful in accordance with the operation accepted by the attack operation accepting part.

16. The information processing system according to claim 1,
wherein the second touch panel is provided in adjacent to the display part.

17. The information processing system according to claim 1,
wherein the display part and the first touch panel are disposed on a face opposite to a face having the second touch panel.

18. The information processing system according to claim 1, further comprising:
a first housing in which the display part and the first touch panel are disposed; and
a second housing rotatable with respect to the first housing in which the second touch panel is disposed,
wherein the second housing is rotatable to a position where the display part and the first touch panel are disposed on a face opposite to a face having the second touch panel.

19. The information processing system according to claim 1, further comprising:
a first housing in which the display part and the first touch panel are disposed;
a second housing in which the second touch panel is disposed; and
a communication part that transmits/receives information to/from the first housing and the second housing.

20. An information processing system comprising:
a pointing device that inputs a position in a display part for displaying an image;
a touch panel that detects a touch position;
a change calculating part that calculates a change in the touch position on the touch panel; and
an information processing part that executes information processing in accordance with the position input by the pointing device and the change calculated by the change calculating part.

21. An information processor comprising:
a display part that displays an image;
a first touch panel that is provided in the display part and detects a touch position;
a second touch panel that detects a touch position;
a change calculating part that calculates a change in the touch position on the second touch panel; and
an information processing part that executes information processing in accordance with the touch position detected by the first touch panel and the change calculated by the change calculating part.

22. An information processing method, using an information processing system including a display part for displaying an image, a first touch panel provided in the display part for detecting a touch position and a second touch panel for detecting a touch position, comprising:
a change calculating step of calculating a change in the touch position on the second touch panel; and
an information processing step of executing information processing in accordance with the touch position detected by the first touch panel and the change calculated in the change calculating step.

23. An information processing method, using an information processing system including a pointing device for inputting a position in a display part for displaying an image and a touch panel for detecting a touch position, comprising:
a change calculating step of calculating a change in the touch position on the touch panel; and
an information processing step of executing information processing in accordance with the position input by the pointing device and the change calculated in the change calculating step.

24. A non-transitory recording medium for causing an information processing system, which includes a display part for displaying an image, a first touch panel provided in the display part for detecting a touch position and a second touch panel for detecting a touch position, to function as:
change calculating means that calculates a change in the touch position on the second touch panel; and
information processing means that executes information processing in accordance with the touch position detected by the first touch panel and the change calculated by the change calculating means.
